(19) United States
(12) Patent Application Publication
(10) Pub. No.: US 2017/0310434 A1
(43) Pub. Date: Oct. 26, 2017

(54) USER TERMINAL, RADIO BASE STATION AND RADIO COMMUNICATION METHOD

(71) Applicant: NTT DOCOMO, INC., Tokyo (JP)

(72) Inventors: Hiroki Harada, Tokyo (JP); Satoshi Nagata, Tokyo (JP); Yu Jiang, Beijing (CN); Liu Liu, Beijing (CN); Jing Wang, Beijing (CN); Huiling Jiang, Beijing (CN)

(73) Assignee: NTT DOCOMO, INC., Tokyo (JP)

(21) Appl. No.: 15/523,557

(22) PCT Filed: Oct. 9, 2015
(86) PCT No.: PCT/JP2015/078746

§ 371 Date: May 1, 2017

(30) Foreign Application Priority Data
Nov. 6, 2014 (JP) 2014-226390

(51) Int. Cl. H04L 5/00; H04W 72/04; H04W 52/38; H04W 16/14; H04B 17/318

(52) U.S. Cl. CPC H04L 5/001; H04W 72/0473; H04W 72/0453; H04B 17/318; H04W 16/14; H04L 5/0053; H04W 52/38

(57) ABSTRACT

A user terminal according to one aspect, can communicate with a radio base station by using a carrier where LBT (Listen Before Talk) is configured, and has a receiving section that receives downlink data that is transmitted based on an LBT result in a specific subframe that includes an LBT symbol, and a control section that controls a receiving process of the downlink data, and, in this user terminal, the specific subframe is allocated periodically, and includes the LBT symbol in the last N symbols, a subframe in a predetermined period following the specific subframe includes a PDCCH (Physical Downlink Control Channel) symbol in several symbols from the beginning, and the control section controls the receiving process of the downlink data, taking into consideration the LBT symbol and the PDCCH symbol.

### TECHNICAL FIELD

The present invention relates to a user terminal, a radio base station and a radio communication method that are applicable to next-generation communication systems.

### BACKGROUND ART

In the UMTS (Universal Mobile Telecommunications System) network, the specifications of long term evolution (LTE) have been drafted for the purpose of further increasing high speed data rates, providing lower delays and so on (see non-patent literature 1). Also, successor systems of LTE (also referred to as, for example, “LTE-advanced” or “LTE enhancement” (hereinafter referred to as “LTE-A”)) have been developed for the purpose of achieving further broadbandization and increased speed beyond LTE.

Furthermore, in relationship to future radio communication systems (Rel. 12 and later versions), a system (“LTE-U” (LTE Unlicensed)) to run an LTE system not only in frequency bands that are licensed to communications providers (operators) (licensed bands), but also in frequency bands that do not require license (unlicensed bands), is under study.

While a licensed band refers to a band in which a specific operator is allowed exclusive use, an unlicensed band (also referred to as a “non-licensed band”) refers to a band which is not limited to a specific operator and in which radio stations can be provided. For unlicensed bands, for example, the 2.4 GHz band and the 5 GHz band where Wi-Fi and Bluetooth (registered trademark) can be used, and the 60 GHz band where millimeter-wave radars can be used are under study for use.

In LTE-U operation, a mode that is premised upon coordination with licensed band LTE is referred to as “LAA” (Licensed-Assisted Access) or “LAA-LTE.” Note that systems that run LTE/LTE-A in unlicensed bands may be collectively referred to as “LAA,” “LTE-U,” “U-LTE,” and so on.

For unlicensed bands in which LAA is run, a study is in progress to introduce interference control functionality in order to allow co-presence with other operators' LTE, Wi-Fi or different systems. In Wi-Fi, LBT (Listen Before Talk) or CCA (Clear Channel Assessment) is used as an interference control function in the same frequency. In Japan and Europe, the LBT function is stipulated as mandatory in systems such as Wi-FI that is run in the 5 GHz unlicensed band.

### CITATION LIST

### Non-Patent Literature

Non-Patent Literature 1:3GPP TS 36.300 “Evolved Universal Terrestrial Radio Access (E-UTRA) and Evolved Universal Terrestrial Radio Access Network (E-UTRAN); Overall description; Stage 2”

### SUMMARY OF INVENTION

### Technical Problem

If, in LTE/LTE-A systems that use carriers with which LBT is configured like unlicensed bands, the symbol configurations of conventional LTE/LTE-A DL signals are applied on an as-is basis, proper processing in user terminals may not be possible.

For example, even when LBT is to be carried out in a predetermined symbol, the radio base station does not transmit data in this symbol, and therefore, unless the user terminal performs the receiving process (for example, rate matching) taking this symbol into consideration, the user terminal is unable to decode the data adequately. By this means, the throughput might drop.

The present invention has been made in view of the above, and it is therefore an object of the present invention to provide a user terminal, a radio base station and a radio communication method that can reduce the decrease of throughput even when a radio base station executes LBT in a system in which LTE/LTE-A is run by using a carrier where LBT is configured.

### Solution to Problem

A user terminal according to one aspect of the present invention provides a user terminal that can communicate with a radio base station by using a carrier in which LBT (Listen Before Talk) is configured, and this user terminal has a receiving section that receives downlink data that is transmitted based on an LBT result in a specific subframe that includes an LBT symbol, and a control section that controls a receiving process of the downlink data, and, in this user terminal, the specific subframe is allocated periodically, and includes the LBT symbol in the last N symbols, a subframe in a predetermined period following the specific subframe includes a PDCCH (Physical Downlink Control Channel) symbol in several symbols from the beginning, and the control section controls the receiving process of the downlink data, taking into consideration the LBT symbol and the PDCCH symbol.

Also, a user terminal according to another aspect of the present invention provides a user terminal that can communicate with a radio base station by using a carrier in which LBT (Listen Before Talk) is configured, and this user terminal has a receiving section that receives downlink data that is transmitted based on an LBT result in a specific subframe that includes an LBT symbol, and a control section that controls a receiving process of the downlink data, taking into consideration the LBT symbol, and, in this user terminal, the specific subframe is allocated periodically, and, in N symbols from the beginning, does not include a PDCCH (Physical Downlink Control Channel) symbol, but includes the LBT symbol.

### Advantageous Effects of Invention

According to the present invention, it is possible to reduce the decrease of throughput even when a radio base station executes LBT in a system in which LTE/LTE-A is run by using a carrier where LBT is configured.

### BRIEF DESCRIPTION OF DRAWINGS

FIG. 1 provide diagrams to show examples of operation modes in radio communication systems in which LTE is used in unlicensed bands;

FIG. 2 diagrams to show examples of radio frame configurations in LBT;

FIG. 3 provide diagrams to show examples of the relationships between a transmission data buffer and transmission data in each eNB category;

FIG. 4 provide diagrams, each explaining an overview of a subframe configuration according to an embodiment of the present invention;

FIG. 5 provide diagrams to show examples of unlicensed band subframe configurations according to embodiment 1;

FIG. 6 is a diagram to show an example of embodiment 1.1;

FIG. 7 is a diagram to show an example of embodiment 1.2;

FIG. 8 provide diagrams to show examples of unlicensed band subframe configurations according to embodiment 2;

FIG. 9 is a diagram to show an example of embodiment 2.2;

FIG. 10 provide diagrams to show examples of unlicensed band subframe configurations according to embodiment 3;

FIG. 11 is a diagram to show an example of embodiment 3.1;

FIG. 12 is a diagram to show an example of embodiment 3.2;

FIG. 13 is a diagram to show an example of soft buffer pollution in HARQ process according to embodiment 1.1;

FIG. 14 is a diagram to show an example of embodiment 4.1;

FIG. 15 is a diagram to show an example of embodiment 4.2;

FIG. 16 is a flowchart to show an example of HARQ process in a user terminal according to embodiment 4.2;

FIG. 17 provide diagrams to show the compatibility between control channels in licensed band/unlicensed band cells and conventional control channels, employing each embodiment of the present invention;

FIG. 18 is a diagram to show an example of a schematic structure of a radio communication system according to an embodiment of the present invention;

FIG. 19 is a diagram to show an example of an overall structure of a radio base station according to an embodiment of the present invention;

FIG. 20 is a diagram to show an example of a functional structure of a radio base station according to an embodiment of the present invention;

FIG. 21 is a diagram to show an example of an overall structure of a user terminal according to an embodiment of the present invention; and

FIG. 22 is a diagram to show an example of a functional structure of a user terminal according to an embodiment of the present invention;

### DESCRIPTION OF EMBODIMENTS

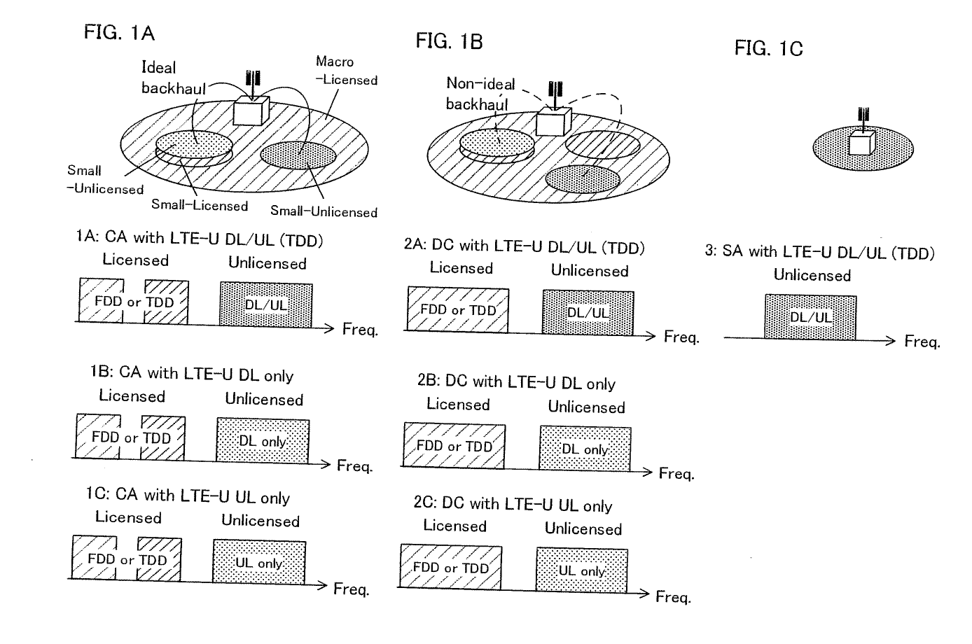

FIG. 1 show examples of operation modes in a radio communication system (LTE-U) in which LTE is run in unlicensed bands. As shown in FIG. 1, there may be a plurality of possible scenarios to use LTE in unlicensed bands, such as carrier aggregation (CA), dual connectivity (DC) and stand-alone (SA).

FIG. 1A shows a scenario to employ carrier aggregation (CA) by using licensed bands and unlicensed bands. CA is a technique to bundle a plurality of frequency blocks (also referred to as “component carriers” (CCs), “carriers” “cells,” etc.) into a wide band. Each CC has, for example, a maximum 20 MHz bandwidth, so that, when maximum five CCs are bundled, a wide band of maximum 100 MHz is provided.

With the example shown in FIG. 1A, a case is illustrated in which a macro cell and/or a small cell to use licensed bands and small cells to use unlicensed bands employ CA. When CA is employed, one radio base station's scheduler controls the scheduling of a plurality of CCs. Based on this, CA may be referred to as “intra-base station CA” (intra-eNB CA) as well.

In this case, the small cells to use unlicensed bands may be TDD carriers that support both DL/UL (scenario 1A), may be carriers for use in DL communication only (scenario 1B), or may be carriers for use in UL communication only (scenario 1C). A carrier that is used for DL communication only is also referred to as a “supplemental downlink” (SDL). Note that FDD and/or TDD can be used in the licensed bands.

Furthermore, a (co-located) structure may be employed here in which a licensed band and an unlicensed band are transmitted and received via one transmitting/receiving point (for example, a radio base station). In this case, the transmitting/receiving point (for example, an LTE/LTE-U base station) can communicate with a user terminal by using both the licensed band and the unlicensed band. Alternatively, it is equally possible to employ a (non-co-located) structure in which a licensed band and an unlicensed band are transmitted and received via different transmitting/receiving points (for example, one via a radio base station and the other one via an RRH (Remote Radio Head) that is connected with the radio base station).

FIG. 1B shows a scenario to employ dual connectivity (DC) by using licensed bands and unlicensed bands. DC is the same as CA in bundling a plurality of CCs (or cells) into a wide band. While CA is based on the premise that CCs (or cells) are connected via ideal backhaul and is capable of coordinated control, which produces very little delay time, DC presumes cases in which cells are connected via non-ideal backhaul, which produces delay time that is more than negligible.

Consequently, in DC, cells are run by separate base stations, and user terminals communicate by connecting with cells (or CCs) that are run by different base stations in different frequencies. So, when DC is employed, a plurality of schedulers are provided individually, and these multiple schedulers each control the scheduling of one or more cells (CCs) managed thereunder. Based on this, DC may be referred to as “inter-base station CA” (inter-eNB CA). Note that, in DC, carrier aggregation (intra-eNB CA) may be employed per individual scheduler (that is, base station) that is provided.

The example shown in FIG. 1B illustrates a case where a macro cell to use a licensed band and small cells to use unlicensed bands employ DC. In this case, the small cells to use unlicensed bands may be carriers that support both DL/UL (scenario 2A), may be carriers for use in DL communication only (scenario 2B), or may be carriers for use in UL communication only (scenario 2C). Note that the macro cell to use a licensed band can use FDD and/or TDD.

In the example shown in FIG. 1C, stand-alone (SA) is employed, in which a cell to run LTE by using an unlicensed band operates alone. Stand-alone here means that communication with terminals is possible without employing CA or DC. In this case, the unlicensed band can be run in a TDD carrier (scenario 3).

In the operation modes of CA and DC shown in FIG. 1A and FIG. 1B, for example, it is possible to use a licensed band CC (macro cell) as a primary cell (PCell) and use an unlicensed band CC (small cell) as a secondary cell (SCell). Here, the primary cell (PCell) refers to the cell that manages RRC connection, handover and so on when CA/DC is used, and is also a cell that requires UL communication such as data and feedback signals from user terminals. The primary cell is always configured in the uplink and the downlink. A secondary cell (SCell) is another cell that is configured in addition to the primary cell when CA/DC is employed. Secondary cells may be configured in the downlink or the uplink alone, or may be configured in both the uplink and the downlink at the same time.

Note that, as shown in above FIG. 1A (CA) and FIG. 1B (DC), a mode to presume the presence of licensed-band LTE (licensed LTE) when running LTE-U is referred to as “LAA” (Licensed-Assisted Access) or “LAA-LTE.” Note that systems that run LTE/LTE-A in unlicensed bands may be collectively referred to as “LAA,” “LTE-U,” “U-LTE” and so on.

In LAA, licensed band LTE and unlicensed band LTE are coordinated so as to allow communication with user terminals. LAA may be structured so that a transmission point (for example, a radio base station) to use a licensed band and a transmission point to use an unlicensed band are, when being a distance apart, connected via a backhaul link (for example, optical fiber, the X2 interface and so on).

Now, in a system in which LTE/LTE-A is run in unlicensed bands (for example, an LAA system), interference control that is for use in the same frequency and that is based on LBT (Listen Before Talk) mechanism is under study in order to allow co-presence with other operators' LTE, Wi-Fi or different systems. This is a kind of transmission control that is based on the result of listening—to be more specific, listening is executed in each transmission point (TP), and transmission is carried out if no signal to exceed a predetermined level is detected.

Note that, in the present description, “listening” refers to the operation which a radio base station and/or a user terminal performs before transmitting signals in order to check whether or not signals to exceed a predetermined level (for example, predetermined power) are being transmitted from other transmission points. Also, this “listening” performed by radio base stations and/or user terminals may be referred to as “LBT” (Listen Before Talk), “CCA” (Clear Channel Assessment), and so on. In the following description, “listening” that is performed by radio base stations and/or user terminals will be also referred to simply as “LBT.”

By introducing LBT in LAA systems, it becomes possible to prevent interference between LAA and Wi-Fi, interference between LAA systems, and so on. Even when user terminals that can be connected are controlled independently for every operator that runs an LAA system, it is possible to reduce interference without learning the details of each operator's control, by means of LBT.

In LTE-systems to use LBT, an LTE-U base station and/or a user terminal perform listening (LBT) before transmitting signals in an unlicensed band cell, and, if no signal from other systems (for example, Wi-Fi) and/or other LAA transmission points is detected, the LTE-U base station and/or the user terminal carry out unlicensed band communication. For example, if received power that is equal to or lower than a predetermined threshold is measured in LBT, the LTE-U base station and/or the user terminal judge that the channel is in an idle state (LBT_idle), and carry out transmission. When a “channel is idle,” this means that, in other words, the channel is not occupied by a certain system, and it is equally possible to say that the channel is “clear,” the channel is “free,” and so on.

On the other hand, procedures that are taken when signals from other systems and/or other LAA transmission points are detected as a result of listening include (1) making a transition to another carrier by way of DFS (Dynamic Frequency Selection), (2) applying transmission power control (TPC), (3) holding (stopping) transmission, and so on. For example, when the received power that is measured in LBT exceeds a predetermined threshold, the LTE-U base station and/or the user terminal judge that the channel is in a busy state (LBT_busy), and do not carry out transmission. In the event of LBT_busy, LBT is carried out again with respect to this channel, and the channel becomes available for use only after it is confirmed that the channel is in the idle state. Note that the method of judging whether a channel is in an idle state/busy state based on LBT is by no means limited to this.

As has been described above, by introducing systems that run LTE/LTE-A in unlicensed bands, it becomes possible to realize flexible resource allocation and traffic adaptation. However, when LBT is used, applying convention frame configurations on an as-is basis may not be effective.

For example, when LBT is to be executed in a predetermined symbol, the does not transmit data in this symbol, and therefore, unless the user terminal performs the receiving process (for example, rate matching) taking this symbol into consideration, the user terminal is unable to decode the data adequate data adequately. For example, the user terminal has to perform the downlink data (PDSCH (Physical Downlink Shared Channel)) receiving process, taking into consideration the number of LBT symbols. Also, whether the control signal (DL grant) to command receipt of unlicensed band data should be provided in licensed bands or in unlicensed bands has not been discussed heretofore.

So, the present inventors have focused on the fact that the subframe configurations in carriers where LBT is configured are highly compatible with conventional LTE/LTE-A subframe configurations. Moreover, the present inventors have arrived at determining the locations of LBT symbols, taking into consideration the symbol locations of conventional control channels, and thereupon made the present invention.

Now, embodiments of the present invention will be described below in detail with reference to the accompanying drawings. Note that, although cases will be described in the following description where a radio base station uses LBT in unlicensed bands in a structure in which a licensed band cell (PCell) and an SDL unlicensed band cell (SCell) constitute carrier aggregation (scenario 1A of FIG. 1), the application of the present invention is by no means limited to this. For example, even when a transmission point transmits an uplink signal (UL signal) by using a downlink signal (DL signal) channel format (PDCCH (Physical Downlink Control Channel), PDSCH, etc.), the subframe configurations (LBT configurations) which will be described below with reference to each embodiment can be employed when this transmission point use LBT.

As LBT schemes, FBE (Frame Based Equipment) and LBE (Load Based Equipment) are currently under study. Differences between these include the frame configurations to use for transmission/receipt, the channel-occupying time, and so on. To be more specific, FBE introduces fixed timings in LBT-related transmitting/receiving configurations. Also, in LBE, the configurations of transmission/receipt pertaining to LBT are not fixed in the time direction, and LBT is carried out on an as-needed basis.

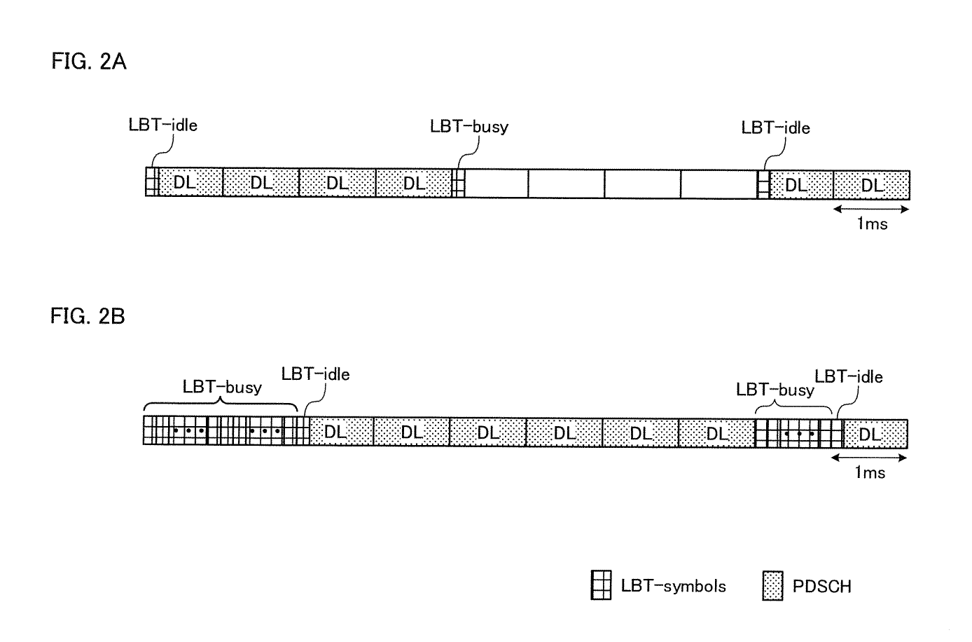

FIG. 2 provide diagrams to show examples of radio frame configurations in LBT. FIG. 2A shows an example of an FBE radio frame configuration. In the event of FBE, the duration of LBT (LBT duration) is fixed, and LBT is carried out in a predetermined number of symbols (for example, two symbols). On the other hand, FIG. 2B shows an example of an LBE radio frame configuration. In the event of LBE, the LBT duration is not fixed. For example, LBT symbols may continue until a predetermined condition is fulfilled. To be more specific, the radio base station may continue executing LBT until LBT-idle is observed.

Note that “LBT symbols” (symbols for LBT) refer to symbols that are used for LBT-related processes. For example, LBT symbols may be used for LBT measurements, or may be used to transmit predetermined signals (for example, the beacon signal (BRS)) depending on the result of LBT. Here, the LBT result refers to information about the state of channel availability (for example, “LBT-idle,” “LBT-busy,” etc.), which is acquired by LBT in carriers where LBT is configured.

According to the present invention, FBE is used for the frame configuration when LBT is performed. This is because the use of FBE shows high compatibility with the subframe-based scheduling/transmission and mechanism of conventional LTE, and can be implemented with little changes to conventional specifications/terminals. That is, on the premise that a number of OFDM symbols are used for LBT, the present invention proposes several methods by linking the following two points:

(1) in which radio resources these LBT symbols are placed; and

(2) when transmission is judged to be possible based on based on an LBT result, how the control channel (control signal) should be transmitted.

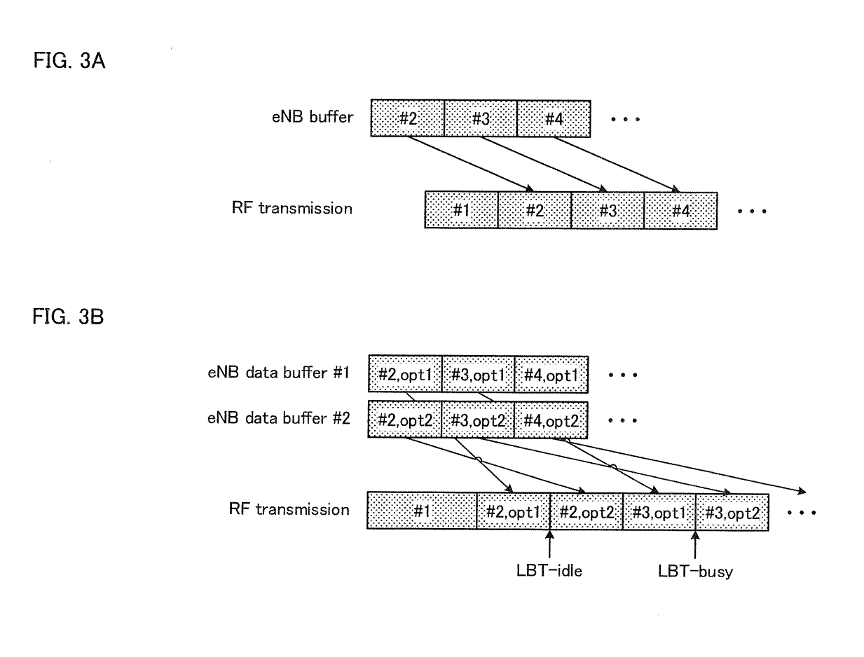

Also, as radio base stations (eNBs) to execute transmission control based on LBT results, two eNBs (eNB category 1, and eNB category 2) may be possible depending on whether or not transmission data can be changed within a subframe. FIG. 3 provide diagrams, each showing an example of the relationship between the transmission data buffer and transmission data in each eNB category.

In either eNB category, the data to be transmitted is first packed into data blocks on a per subframe basis, and stored in a buffer (eNB buffer) provided in the eNB. Then, the eNB picks data from the buffer in each subframe and transmits this (RF transmission). The contents of data blocks include, for example, the data to be transmitted in the PDCCH, the PDSCH and so on.

FIG. 3A show an example of an eNB category 1. In eNB category 1, the data that is transmitted in each subframe does not change. That is, in a given subframe, data that is acquired from the buffer and that corresponds to this subframe is transmitted. For example, the data for subframe #2 is transmitted in subframe #2.

FIG. 3B shows an example of an eNB category 2. In eNB category 2, the data that is transmitted in each subframe can be changed within the subframe. That is, looking at a given subframe, a plurality of pieces of data that corresponds to this subframe may be acquired from the buffer and transmitted. In the example of FIG. 3B, the eNB has two buffers, and can switch between each buffer's data within a subframe. For example, data transmission in a licensed band carrier may be executed as shown in FIG. 3B, and this data transmission can be controlled depending on the result of LBT in the unlicensed band.

Although the eNB first transmits data from buffer #1 (#2, opt1) in subframe #2, LBT-idle is detected in the middle of the subframe, and the transmission data is switched to data from buffer #2 (#2, opt2). Also, although the eNB first transmits data from buffer #1 (#3, opt1) in subframe #3, LBT-busy is detected in the middle of the subframe, and the transmission data is switched to data from buffer #2 (#3, opt2).

In this way, the eNB of eNB category 2 can realize dynamic control, such as executing cross-carrier scheduling (CCS) depending on channel states in unlicensed bands. Although examples of each embodiment will be described below presuming eNB category 1, the application of the present invention is by no means limited to this, and the present invention can be applied to eNB category 2 as well.

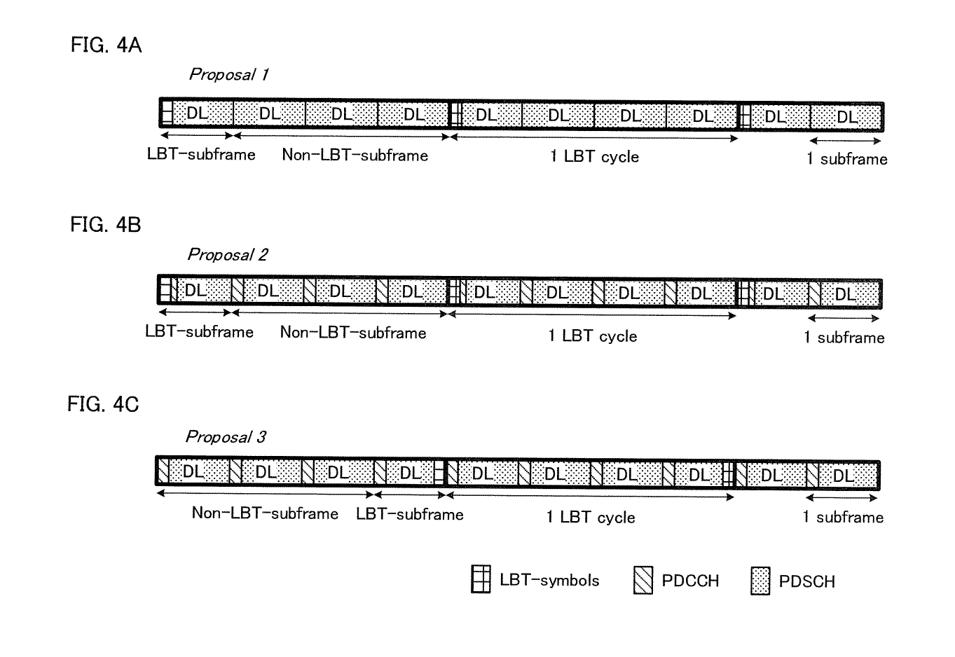

FIG. 4 provide diagrams, each explaining an overview of the subframe configuration according to each embodiment of the present invention. FIG. 4A shows embodiment 1, FIG. 4B shows embodiment 2, and FIG. 4C shows embodiment 3. A subframe in which LBT symbols (symbol where LBT is executed) are placed will be referred to as an “LBT subframe,” and a subframe where no LBT symbol is placed will be referred to as a “non-LBT subframe.”

In the cases shown as examples in FIG. 4, the LBT cycle and the burst length are four subframes. Here, the LBT cycle is the cycle of executing LBT, and the burst length is the period in which signals can be transmitted in a row when the latest LBT result (the result in the most recent LBT subframe) is “LBT-idle.” That is, LBT symbols are periodically included in subframes in the event of LBT-busy, but need not be necessarily included in subframes in the event of LBT-idle.

Note that the LBT cycle and the burst length are not limited to the values shown in FIG. 4. For example, LBT may be executed on a per subframe basis by making the LBT cycle one subframe. Also, a structure may be employed here in which a plurality of LBT symbols are placed in one LBT cycle.

Also, the LBT cycle and the burst length need not be the same. For example, a structure may be used here in which, when the burst length is longer than the LBT cycle, in a predetermined period (period of burst length) following LBT-idle, signals can be transmitted without executing LBT. Also, in the predetermined period (the burst length period) following LBT-idle (to be more accurate, the symbols where LBT was going to be executed), it is possible to use LBT symbols for other purposes than LBT (for example, for DL signal transmission).

As shown in FIG. 4A, according to embodiment 1, the first N symbols of the first subframe in an LBT cycle are made LBT symbols. In embodiment 1, the PDCCH is not transmitted in unlicensed bands and is transmitted in licensed bands instead, and/or the EPDCCH (Enhanced Physical Downlink Control Channel) is transmitted in unlicensed bands.

As shown in FIG. 4B, according to embodiment 2, the first N symbols of the first subframe in an LBT cycle are made LBT symbols, and several symbols that follow the LBT symbols are made PDCCH symbols. In embodiment 2, subframes other than the LBT subframe (non-LBT subframes) are the same as the subframe configuration in conventional LTE.

As shown in FIG. 4C, according to embodiment 3, the last N symbols of the last subframe in an LBT cycle are made LBT symbols. In embodiment 3, again, the non-LBT subframes are the same as the subframe configuration in conventional LTE.

### Embodiment 1

According to embodiment 1, the first N symbols of the first subframe in an LBT cycle are made LBT symbols. Here, N has only to be a value that is sufficient to implement the LBT function in LAA, and can be, for example, N=1, 2, 3, and so on. Data transmission in symbols other than the LBT symbols in an LBT subframe and all symbols in non-LBT subframes may be judged based on the result of LBT in the LBT cycle. Also, in each subframe according to embodiment 1, the PDCCH is not transmitted.

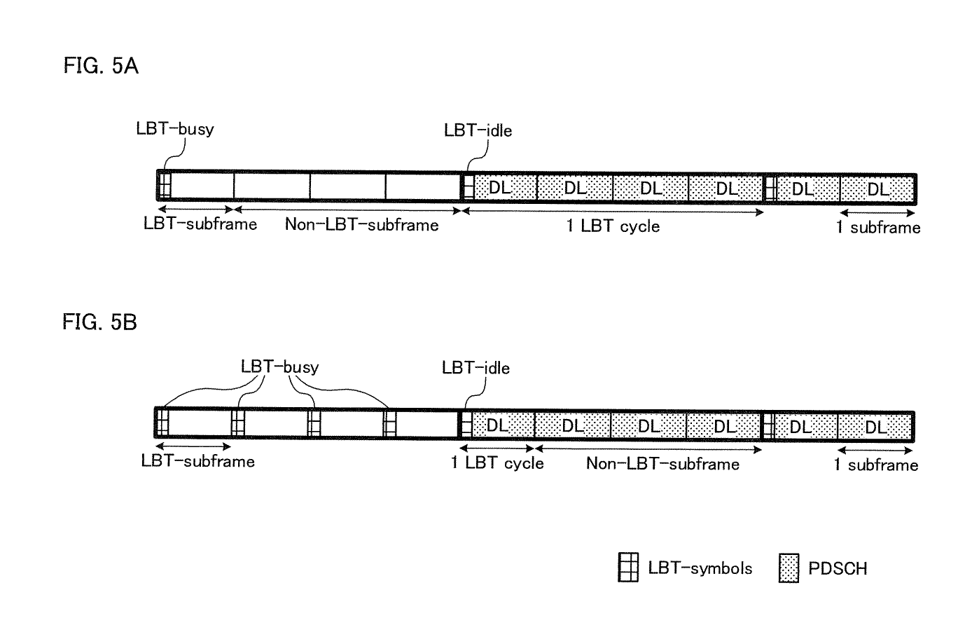

FIG. 5 provide diagrams to show examples of unlicensed band subframe configurations according to embodiment 1. FIG. 5B shows an example of a case where the LBT cycle and the burst length are the same, that is, four subframes. When a result of LBT yields “LBT-busy,” the radio base station cannot transmit data in this LBT cycle (the first to the fourth subframe from the left). If, on the other hand, the result of LBT yields “LBT-idle,” the radio base station can transmit data in this LBT cycle (the fifth to the eighth subframe from the left). Also, when the LBT cycle is over, LBT is executed again (the ninth subframe from the left).

FIG. 5B show an example of a case where the LBT cycle is one subframe and the burst length is four subframes. When a result of LBT yields “LBT-idle,” the radio base station can transmit data, without executing LBT, during the period of the burst length (from the left the fifth to the eighth subframe).

In embodiment 1, in order to learn the subframe configuration and perform the receiving process (in order to take the LBT symbols into consideration), the user terminal has to learn information (the following parameters) about the subframe/symbol configuration to which symbol-level LBT is applied:

the LBT cycle (the length of the LBT cycle), L;

the number of LBT symbols (the length of the LBT period), N;

the LBT subframe offset (timing offset), O; and

the burst length, B.

Here, it is preferable to configure N to be equal to less than the maximum number of symbols of the conventional PDCCH (that is, three), but this is by no means limiting. Also, the LBT subframe offset is an offset to show in which subframe in a radio frame LBT is carried out, and is represented by, for example, the difference between a reference subframe index and the LBT subframe index.

The information about the subframe/symbol configuration to which LBT is applied may be reported in a control signal (for example, DCI (Downlink Control Information)), may be reported in higher layer signaling (for example, MAC signaling, RRC signaling, a broadcast signal, etc.), or needs not be reported when fixed values are configured in common between the user terminal and the radio base station in advance. Also, a report may be sent from a licensed band (PCell) or may be sent from an unlicensed band (SCell).

For example, for the number of LBT symbols, a fixed value may be configured in advance, or may be configured via higher layer signaling. Also, the burst length, when not reported, may be determined based on the length of the LBT cycle, or may be made for example, the same as the length of the LBT cycle. Also, when the LBT cycle is 1 ms, the LBT subframe timing offset needs not be reported.

Also, the user terminal needs to employ rate matching, without the PDCCH, in LBT subframes.

In embodiment 1, the PDCCH is not transmitted in unlicensed bands, and therefore control information (DCI) is reported in the PDCCH/EPDCCH of a licensed band (embodiment 1.1), and the EPDCCH of an unlicensed band (embodiment 1.2).

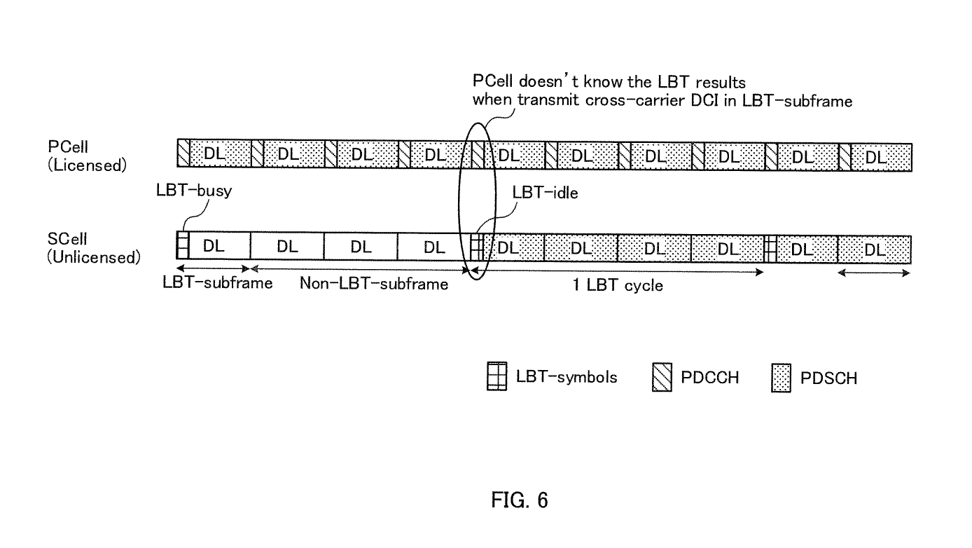

FIG. 6 is a diagram to show an example of embodiment 1.1. In FIG. 6, the PDSCH of an SCell, allocated to an unlicensed band, is subjected to cross-carrier scheduling (CCS) by using the PDCCH of a PCell (DL assignment), allocated to a licensed band. The PCell and the SCell are synchronized via carrier aggregation, and therefore the PDCCH of the PCell and the LBT period in the SCell overlap.

Here, given that the PDCCH of the PCell and the LBT period in the SCell overlap, it is likely that a problem arises in the HARQ (Hybrid Automatic Repeat reQuest) process. When the PCell transmits DCI for CCS in LBT subframes, the PCell does not know the results of LBT in the SCell. Consequently, even if data transmission by the SCell is reported in the PCell's DCI, the radio base station is nevertheless unable to carry out transmission in the SCell in the event of LBT-busy. Note that, even when the EPDCCH is used, in eNB category 1, the content of transmission cannot be changed in the middle of a subframe after LBT, and therefore the same problem might arise.

In this way, the phenomenon where, although the radio base station commands the user terminal to receive downlink data, the radio base station is nevertheless unable to transmit the downlink data due to the result of LBT, is referred to as “fake transmission.” This problem will be described in detail in embodiment 4 of the present invention, which will be described later.

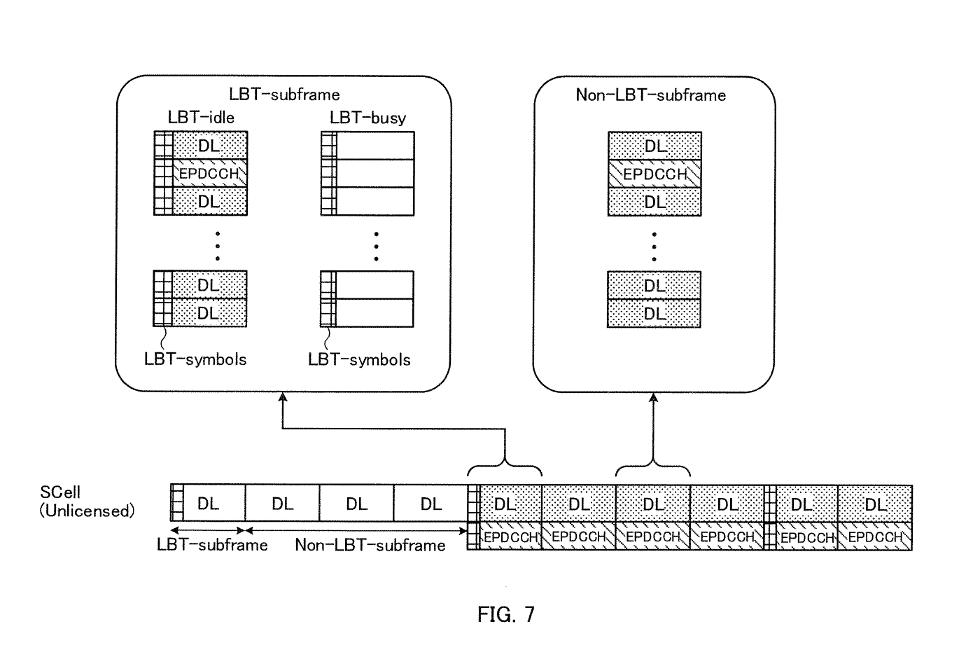

FIG. 7 is a diagram to show an example of embodiment 1.2. In FIG. 7, in DCI that is transmitted in an SCell of an unlicensed band in the event of LBT-idle, this SCell's scheduling information is indicated. Given that, according to embodiment 1.2, the execution of LBT and the transmission of control signals and data signals are kept within the SCell, and DCI is transmitted after LBT-idle is definitive, the above-described fake transmission does not occur.

As shown in FIG. 7, in an LBT subframe, when the result of LBT using LBT symbols yields “LBT-busy,” no transmission is carried out in the following symbols in this subframe and in the symbols before the next LBT subframe. If, on the other hand, the result of LBT in the LBT subframe yields “LBT-idle,” an EPDCCH for commanding receipt of a DL signal (PDSCH) is transmitted in a predetermined frequency location in this subframe. Note that this EPDCCH may include information about the PDSCH in the LBT subframe, or may include information about the PDSCH in subframes apart from the LBT subframe. Also, it is possible to bundle and schedule several subframes together in order to reduce the overhead (cross-subframe scheduling).

When the result of LBT in the same LBT cycle yields “LBT-idle,” in non-LBT subframes, an EPDCCH for commanding receipt of the PDSCH is transmitted in a predetermined frequency location, as in the LBT subframe. Note that, when cross-subframe scheduling is used, there may be subframes in which the EPDCCH is not transmitted.

frequency location to allocate EPDCCH may be the same in each subframe in an LBT cycle, or may vary. Information about the frequency location where the EPDCCH is allocated may be reported from the licensed band (PCell) through higher layer signaling (for example, RRC signaling, a broadcast signal, etc.), or may be reported to the user terminal in advance in the unlicensed band (SCell). Also, a structure may be employed here in which the EPDCCH is transmitted in the common search space that is configured in the unlicensed band (SCell).

As has been described above, according to embodiment 1 of the present invention, it is possible to share the same frequency with other systems in a carrier where LBT is configured. Also, since the PDCCH is not allocated to the carrier where LBT is configured, it is possible to improve the throughput related to data transmission.

### Embodiment 2

With embodiment 2, the first N symbols of the first subframe in an LBT cycle are made LBT symbols, and M symbols that follow the LBT symbols are made PDCCH symbols. Here, N has only to be a value that is sufficient to implement the LBT function in LAA, and, for example, N=2 and so on. Also, although it is preferable to configure M so that N+M is equal to less than the maximum number of symbols of the conventional PDCCH (that is, three), this is by no means limiting. PDCCH/PDSCH transmission in symbols other than the LBT symbols in an LBT subframe and in all symbols of non-LBT subframes is judged based on the result of LBT in the current LBT cycle.

In embodiment 2, the PDCCH is transmitted in the event of LBT-idle. Although, in an LBT subframe, the PDCCH is transmitted in M symbols that follow the LBT symbols, in a non-LBT subframe, the PDCCH may be transmitted in the same symbols as those in conventional LTE/LTE-A.

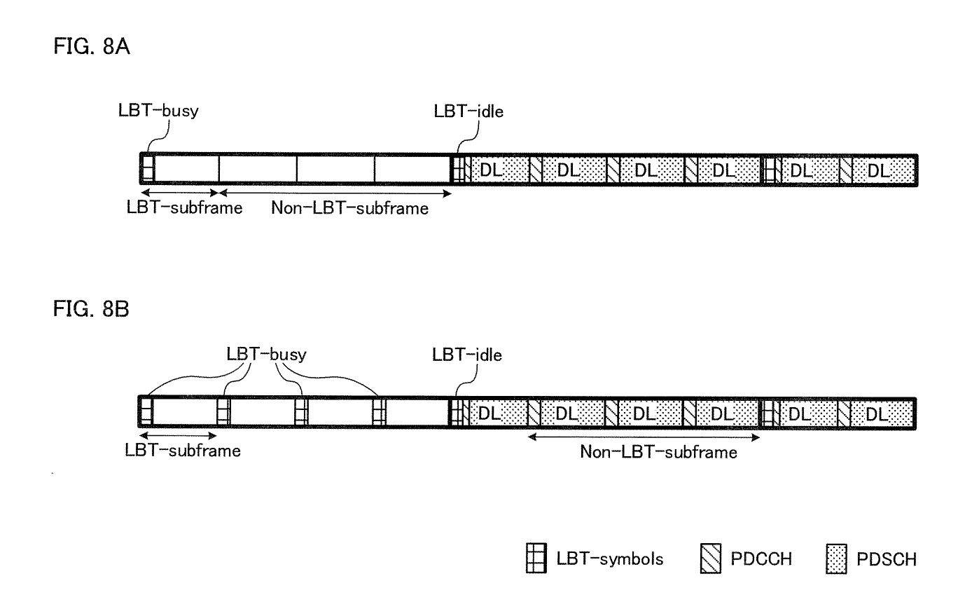

FIG. 8 provide diagrams to show examples of unlicensed band subframe configurations according to embodiment 2. FIG. 8A show an example of a case where the LBT cycle and the burst length are the same, that is, four subframes. When a result of LBT yields “LBT-busy,” the radio base station cannot transmit data in this LBT cycle (the first to the fourth subframe from the left). If, on the other hand, the result of LBT yields “LBT-idle,” the radio base station can transmit data in this LBT cycle (the fifth to the eighth subframe from the left). Also, in an LBT cycle of LBT-idle, the PDCCH is transmitted in each subframe. Also, when the LBT cycle is over, LBT is executed again (the ninth subframe from the left).

FIG. 8B shows an example of a case where the LBT cycle is one subframe and the burst length is four subframes. When a result of LBT yields “LBT-idle,” the radio base station can transmit data, without executing LBT, during the period of the burst length (the fifth to the eighth subframe from the left).

In embodiment 2, in order to learn the subframe configuration and perform the receiving process (in order to take the LBT symbols and the PDCCH symbols into consideration), the user terminal has to learn information (the following parameters) about the subframe/symbol configuration to which symbol-level LBT is applied:

the LBT cycle (the length of the LBT cycle), L;

the number of PDCCH symbols that follow the LBT symbols, M;

the number of LBT symbols (the length of the LBT period) N,

the LBT subframe offset (timing offset), O; and

the burst length, B.

The information about the subframe/symbol configuration to which LBT is applied may be reported in a control signal (for example, DCI (Downlink Control Information)), may be reported in higher layer signaling (for example, MAC signaling, RRC signaling, a broadcast signal, etc.), or needs not be reported when fixed values are configured in common between the user terminal and the radio base station in advance. Also, a report may be sent from a licensed band (PCell) or may be sent from an unlicensed band (SCell).

The burst length, when not reported, may be determined based on the length of the LBT cycle, or may be made for example, the same as the length of the LBT cycle. Also, when the LBT cycle is 1 ms, the LBT subframe timing offset needs not be reported.

In an LBT subframe, the user terminal needs carry out PDCCH detection after the LBT symbols. For example, when the LBT cycle is longer than one subframe, the user terminal identifies a subframes in which the PDCCH symbol timing is different (LBT subframe) based on the LBT subframe offset that is reported.

Also, when the burst length is longer than the LBT cycle (for example, the LBT cycle=1 ms and the burst length=4 ms), before a burst starts, the user terminal performs PDCCH detection, assuming that the PDCCH starts after the LBT symbols (presuming an LBT subframe), and, after identifying a burst, the user terminal demodulates the PDCCH at the beginning of the subframe (presuming a normal subframe).

The user terminal can judge whether or not a burst is going to be started based on the PCFICH (Physical Control Format Indicator Channel). First, the user terminal tries to detect the PCFICH that is directed to a certain user terminal in the PDCCH symbols after the LBT symbols. If the PCFICH is indeed detected, this means that the PDCCH is going to be transmitted—that is, a burst is going to start. Also, even of the result of this detection is not directed to the subject terminal, signals for the subject terminal may be transmitted in subsequent subframes in the LBT cycle, so that the user terminal having detected the PCFICH has only to try detecting the DCI that is included in the PDCCH in the rest of the non-LBT subframes.

Also, the user terminal needs to apply rate matching based on N and M in LBT subframes.

In embodiment 2, control information is reported in the PDCCH/EPDCCH of a licensed band (embodiment 2.1), or reported in the PDCCH/EPDCCH of an unlicensed band (embodiment 2.2).

Embodiment 2.1 is the same as embodiment 1.1, and therefore its description will be omitted. With embodiment 2.1, too, the problem of fake transmission needs to be taken into consideration.

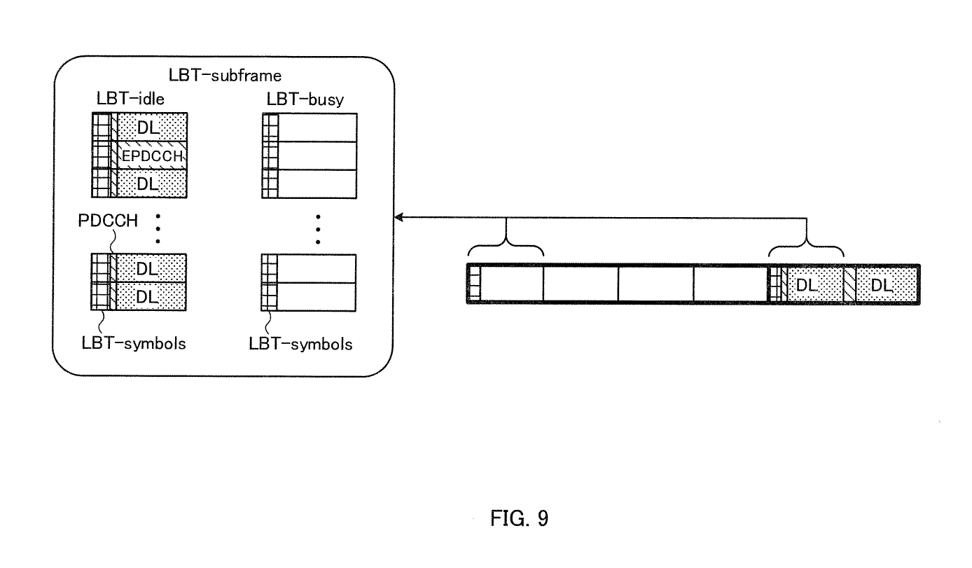

FIG. 9 is a diagram to show an example of embodiment 2.2. In FIG. 9, in DCI that is transmitted in an SCell of an unlicensed band in the event of LBT-idle, this SCell's scheduling information is indicated. Given that, according to embodiment 2.2, DCI is transmitted after LBT-idle is definitive, the above-described fake transmission does not occur.

As shown in FIG. 9, in an LBT subframe, when the result of LBT using LBT symbols yields “LBT-busy,” no transmission is carried out in the following symbols in this subframe and in the symbols before the next LBT subframe. If, on the other hand, the result of LBT in the LBT subframe yields “LBT-idle,” in this subframe, the PDCCH is transmitted after the LBT symbols, and, in a predetermined frequency location after the PDCCH symbols, an EPDCCH for commanding receipt of a DL signal (PDSCH) is transmitted. Note that this EPDCCH may include information about the PDSCH in the LBT subframe, or may include information about the PDSCH in subframes other than the LBT subframe. Also, it is possible to bundle and schedule several subframes together in order to reduce the overhead (cross-subframe scheduling).

As has been described above, according to embodiment 2 of the present invention, it becomes possible to share the same frequency with other systems in a carrier where LBT is configured. Also, since the PDCCH is allocated to the carrier where LBT is configured, it is possible to execute, in this carrier, scheduling that is highly compatible with conventional LTE systems.

### Embodiment 3

With embodiment 3, the last N symbols of the last subframe in an LBT cycle are made LBT symbols. Here, N has only to be a value that is sufficient to implement the LBT function in LAA, and, for example, N=1, 2, 3 and so on. PDCCH/PDSCH transmission in symbols other than the LBT symbols in an LBT subframe and in all symbols of non-LBT subframes is judged based on the result of LBT in the current LBT cycle.

In embodiment 3, the PDCCH is transmitted in the event of LBT-idle. In LBT subframes and non-LBT subframes, the PDCCH may be transmitted in the same symbols as in conventional LTE/LTE-A.

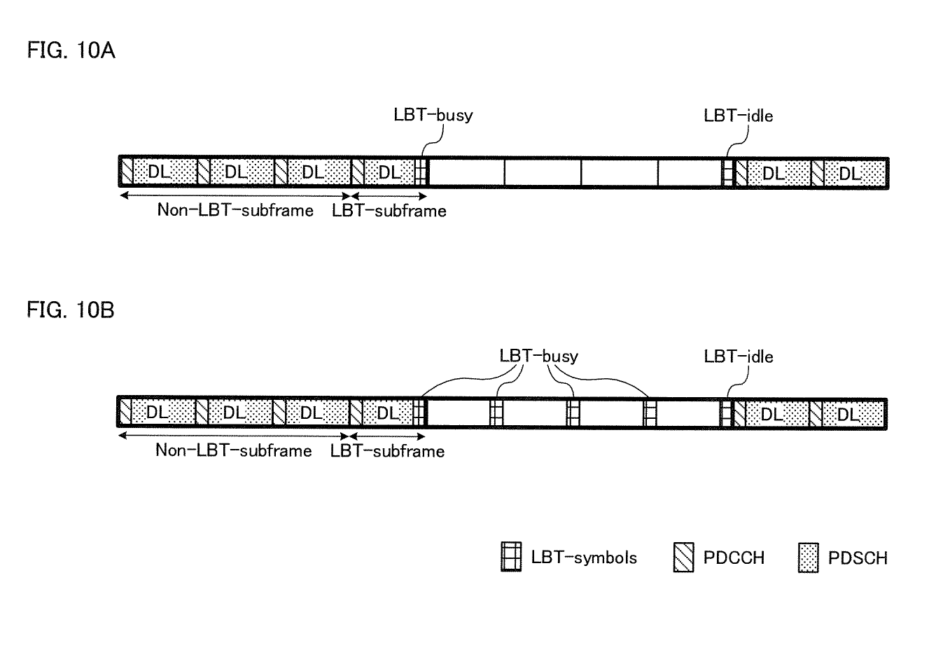

FIG. 10 provide diagrams to show examples of unlicensed band subframe configurations according to embodiment 3. FIG. 10A show an example of a case where the LBT cycle and the burst length are the same, that is, four subframes. When the result of LBT in the previous cycle is “LBT-busy,” the radio base station cannot transmit data in the current LBT cycle (the fifth to the eighth subframe from the left). If, on the other hand, the result of LBT in the previous cycle is “LBT-idle,” the radio base station can transmit data in the current LBT cycle (the first to the fourth, and the ninth to the tenth subframe from the left). Also, in an LBT-idle LBT cycle, the PDCCH is transmitted in each subframe. Also, when the LBT cycle is over, LBT is executed again (the fourth and the eighth subframe from the left).

FIG. 10B show an example of a case where the LBT cycle is one subframe and the burst length is four subframes. If the previous LBT result is “LBT-idle,” the radio base station can transmit data, without executing LBT, during the period of the burst length (the first to the fourth, and the ninth to the tenth subframe from the left).

In embodiment 3, in order to learn the subframe configuration and perform the receiving process (in order to take the LBT symbols and the PDCCH symbols into consideration), the user terminal has to learn information (the following parameters) about the subframe/symbol configuration to which symbol-level LBT is applied:

the LBT cycle (the length of the LBT cycle), L;

the number of LBT symbols (the length of the LBT period), N;

the LBT subframe offset (the timing offset), O; and

the burst length, B.

The information about the subframe/symbol configuration to which LBT is applied may be reported in a control signal (DCI), may be reported in higher layer signaling (for example, MAC signaling, RRC signaling, a broadcast signal, etc.), or needs not be reported when fixed values are configured in common between the user terminal and the radio base station in advance. Also, a report may be sent from a licensed band (PCell) or may be sent from an unlicensed band (SCell).

The burst length, when not reported, may be determined based on the length of the LBT cycle, or may be made for example, the same as the length of the LBT cycle. Also, according to embodiment 3, the user terminal can identify the beginning of a bust by way detecting the PDCCH, and therefore can judge that the subframe that comes the burst length after the start of a burst is an LBT subframe. Therefore, the LBT subframe timing offset needs not be reported.

Also, the user terminal needs to apply rate matching based on N in LBT subframes.

In embodiment 3, control information is reported in the PDCCH/EPDCCH of a licensed band (embodiment 3.1), or reported in the PDCCH/EPDCCH of an unlicensed band (embodiment 3.2).

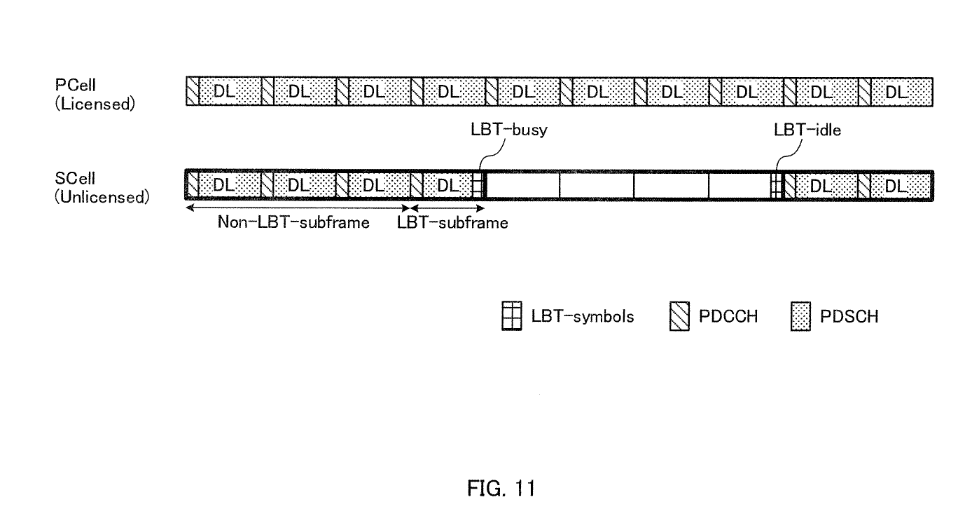

FIG. 11 is a diagram to show an example of embodiment 3.1. As shown in FIG. 11, the PDCCH of a PCell and the LBT periods in an SCell do not overlap. To be more specific, depending on a result of LBT in a subframe of the SCell (the fourth subframe from the left), cross-carrier scheduling for the SCell's subframes is carried out in subframes of the PCell (the fifth to the eighth subframe from the left). Therefore, the problem of fake transmission arises.

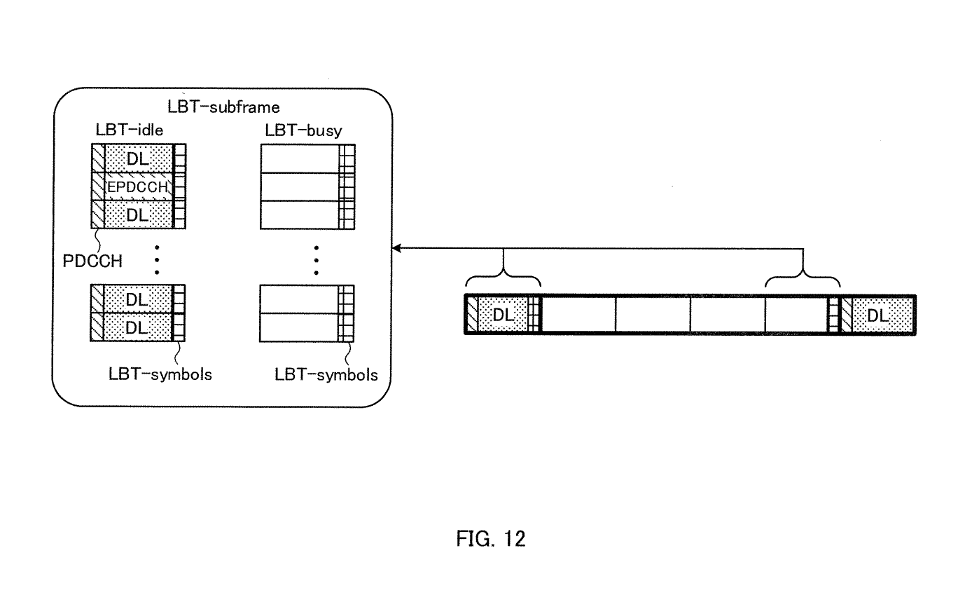

FIG. 12 is a diagram to show an example of embodiment 3.2. In FIG. 12, in DCI that is transmitted in an SCell of an unlicensed band in the event of LBT-idle, this SCell's scheduling information is indicated. Given that, according to embodiment 3.2, DCI is transmitted after LBT-idle is definitive, the above-described fake transmission does not occur.

As shown in FIG. 12, if the result of LBT in the previous cycle is “LBT-busy,” in the present LBT cycle, no transmission is carried out in symbols other than the LBT symbols of the LBT subframe or in all symbols of non-LBT subframes. If, on the other hand, the previous LBT result is “LBT-idle,” in each subframe, the PDCCH and/or the EPDCCH is transmitted, and a DL signal (PDSCH) is transmitted. Note that this PDCCH/EPDCCH may include information about the scheduling of a plurality of subframes.

As has been described above, according to embodiment 3 of the present invention, it becomes possible to share the same frequency with other systems in a carrier where LBT is configured. Also, given that the PDCCH can be allocated in the carrier where LBT is configured, it becomes possible to execute, in this carrier, scheduling that is highly compatible with conventional LTE systems.

### Embodiment 4

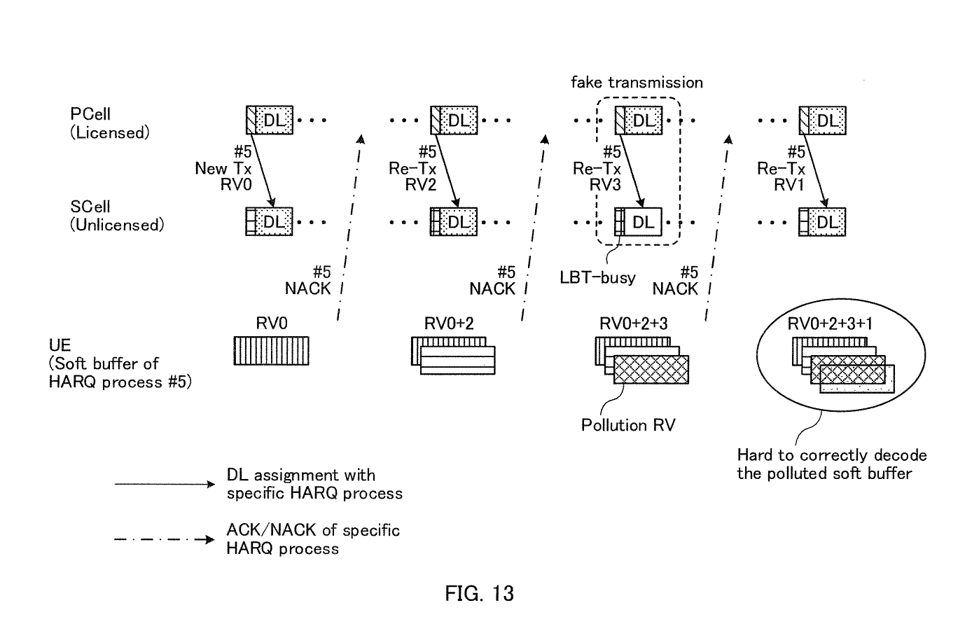

Embodiment 4 relates to the problem of fake transmission which has been described above in embodiments 1.1 and 2.1. When fake transmission occurs, soft-buffers that are used in the user terminal for HARQ are polluted. FIG. 13 is a diagram to show an example of pollution of HARQ process soft buffers according to embodiment 1.1. FIG. 13 shows an example in which given data is transmitted and re-transmitted in an SCell. Although #5 is used for the HARQ process number here, this is simply an example, and the HARQ process number according to embodiments of the present invention is by no means limited to this.

In HARQ retransmission, the user terminal combines (soft combining) pieces of transmission data (retransmission data) that correspond to a plurality of RVs (Redundancy Version), and, by this means, can decode the original data efficiently, without wasting much of the data that is transmitted. In FIG. 13, the initial transmission data corresponds to RV0, the transmission data of the second time correspond to RV2, the transmission data of the third time corresponds to RV3, and the transmission data of the fourth time corresponds to RV1.

Here, when LBT-busy is detected at the transmission timing of RV3, the data to correspond to RV3 is not transmitted actually, which produces fake transmission. Meanwhile, since a DL grant (DL assignment) is reported to the user terminal in the PCell, the user terminal tries to receive the data to correspond to RV3. As a result of this, what is stored in the soft-buffer as the data to correspond to RV3 is noise and/or surrounding interference, and is not a received signal that is valid for HARQ combining. Therefore, RV3 becomes a polluted RV (“pollution RV”). Once a polluted RV is stored in a soft-buffer, after this, it becomes difficult to decode data properly by using this soft-buffer. The same problem might occur in embodiment 2.1 as well.

So, the present inventors have studied the method of reducing the impact of soft-buffer pollution caused by fake transmission, and arrived at embodiment 4 of the present invention. Embodiment 4 encompasses a method of starting from the initial transmission again when an HARQ process is polluted (embodiment 4.1), and a method of using two soft-buffers in each HARQ process (embodiment 4.2).

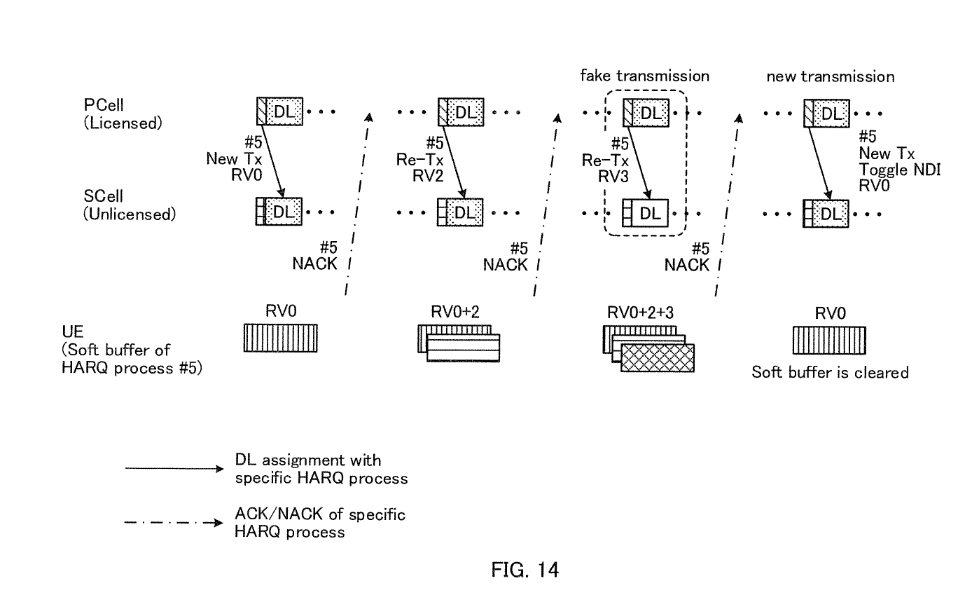

In embodiment 4.1, when fake transmission occurs, the eNB transmits SCell data again in the next transmission timing. FIG. 14 is a diagram to show an example of embodiment 4.1. FIG. 14 shows an example in which fake transmission is produced, as in FIG. 13.

According to embodiment 4.1, when the PCell identifies the occurrence of fake transmission in the SCell, and, furthermore, receives a NACK in response to the HARQ process, the PCell carries out the data transmission all over again. To be more specific, the eNB toggles the NDI (New Data Indicator) of a DL grant in the next transmission timing (sets a bit), and carries out transmission from RV0 again.

The user terminal, upon receiving the DL grant with a toggled NDI, clears the soft-buffer once. Then, the user terminal stores the data to correspond to RV0, having been received on the PDSCH of the SCell, in the soft-buffer. As understood from the above, embodiment 4.1 does not make significant changes to the conventional HARQ process, and therefore is effective in terms of the cost of implementation.

Note that, although the PCell needs to identify the occurrence of fake transmission in the SCell, this identification is easy when the PCell and the SCell are implemented by the eNB. When the PCell and the SCell are implemented by different eNBs, it may be possible to report information about the occurrence of fake transmission from the eNB forming the SCell to the eNB forming the PCell, through wire connection (for example, the X2 interface), wireless connection, and so on. This information may include, for example, information about the user terminal ID, the HARQ process number and so on.

In embodiment 4.2, two soft-buffers are used in each HARQ process. One buffer (decoding soft-buffer) is used in data decoding, and the other buffer (storage soft-buffer) is used to store combined valid RVs (RVs that are not fake-transmission). Also, with embodiment 4.2, when fake transmission occurs in the SCell, the PCell reports, in the next transmission timing, information as to “whether or not the RV that was transmitted last time was valid (that is, whether or not the previous data transmission timing was LBT-idle).” This information may be referred to as a fake RV indicator.

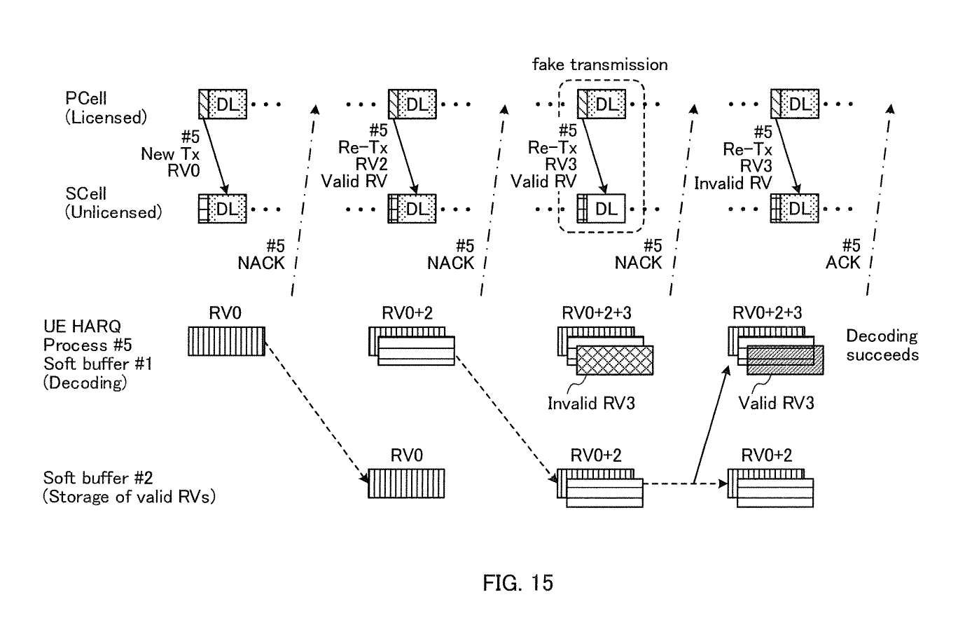

FIG. 15 is a diagram to show an example of embodiment 4.2. An example shown in which fake transmission occurs, as in FIG. 13. The user terminal combines the RVs that are received, in order, in the first soft-buffer (soft buffer #1), which is a decoding soft-buffer. Meanwhile, in the second soft-buffer (soft buffer #2), which is a storage soft-buffer, the user terminal combines only the RVs that are reported to be valid by fake RV indicators. That is, in the second soft-buffer, the latest state of an un-polluted soft-buffer is stored.

In FIG. 15, first, RV0 is transmitted, and the user terminal stores RV0 in the first soft-buffer. In this case, this is cleared if there is data in the second soft-buffer.

RV0 is not fake-transmitted, so that, together with RV2, information to indicate a “valid RV” is reported as a fake RV indicator, in response to a NACK from the user terminal. In this case, after duplicating the content of the first soft-buffer (RV0) in the second soft-buffer, the user terminal combines RV2 in the first soft-buffer.

RV2 is not fake-transmitted, so that, together with RV3, information to indicate a “valid RV” is reported as a fake RV indicator, in response to a second NACK from the user terminal. In this case, after duplicating RV0+2, which is present in the first soft-buffer, in the second soft-buffer, the user terminal combines RV3 in the first soft-buffer. Note that RV3 is fake transmitted, and therefore RV3 received in the user terminal is an invalid RV.

Since RV3 is fake-transmitted, in response to a NACK that is issued again from the user terminal, RV3 is reported once again, and, furthermore, information to indicate an “invalid RV” is reported as a fake RV indicator.

In this case, the user terminal once clears RV0+2+3 (invalid), which is present in the first soft-buffer, and then duplicates RV0+2 from the second soft-buffer into the first soft-buffer, and combines newly-received RV3 with the data of the first soft-buffer. When the decoding finally succeeds after having gone through all of these HARQ processes, the user terminal transmits an ACK.

As understood from the above, although, according to embodiment 4.2, the user terminal requires a plurality of soft-buffers, it is possible to make efficient use of valid RVs that have been received in the past, and reduce the time it takes to transmit DL data (transport blocks).

Note that, for the signaling of fake RV indicators, it is possible to provide a new bit (for example, one bit) that indicates whether or not an RV in a soft-buffer is valid, as information to include in DCI, and send the signaling by using this bit. Also, the signaling of fake RV indicators may be configured to be understood by the user terminal by changing the interpretation of existing RV information within DCI, without using a new bit.

For example, based on information that is included in a DL grant that is received and an RV that is used to combine data in the decoding soft-buffer, the user terminal may judge whether or not the data to correspond to this RV is valid.

To be more specific, based on the NDI and RV included in DCI that is received and the RV that is present in the decoding soft-buffer, the user terminal may:

(1) when RV0 is present in the decoding soft-buffer, the RV that is included in the DCI that is received is RV0 and the NDI is toggled, judge that RV0 in the decoding soft-buffer is an invalid RV (that is, judge that the previous transmission of RV0 was fake transmission and the current transmission of RV0 is the initial transmission);

(2) when RV0 is present in the decoding soft-buffer, the RV that is included in the DCI that is received is RV0 and the NDI is not toggled, combine RV0 in the decoding soft-buffer and RV0 that is received (that is, judge that the previous transmission of RV0 was normal transmission and the current transmission of RV0 is retransmission); and

(3) when the same RV as the RV that is included in the DCI that is received is present in the decoding soft-buffer (not including RV0), judge that the RV in the decoding soft-buffer is an invalid RV (that is, judge that the previous transmission of the RV was fake transmission).

That is, as for RV0, the same data may be retransmitted and combined even when RV0 is not fake-transmitted.

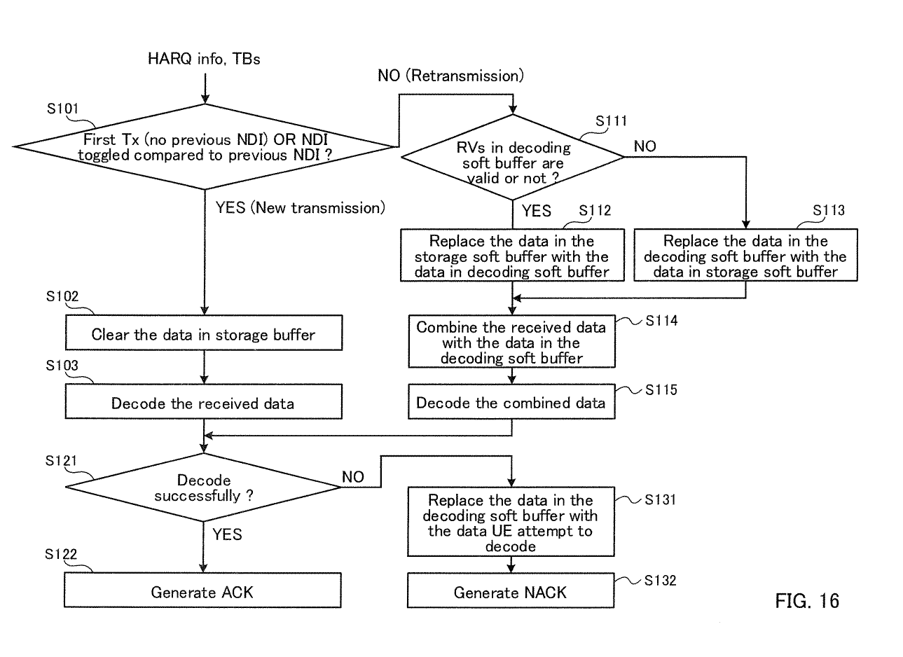

FIG. 16 is a flowchart to show an example of HARQ process in the user terminal according to embodiment 4.2. The user terminal carries information about HARQ, information about transport blocks received (RVs, NDIs, etc.) and so on.

The user terminal judges whether data that is received is the first transmission data (that is, no previous NDI is present), or whether the NDI is toggled, in comparison to the previous NDI (step S101). If the judgement is true (step S101: YES), the user terminal deletes the data in the storage soft-buffer (step S102). Then, the user terminal tries to decode the received data (step S103).

On the other hand, if the judgement is false (step S101: NO), the user terminal further judges whether or not the RV that is included in the decoding soft-buffer is valid (step S111). This judgment can be made via fake RV indicator signaling, as described earlier.

When the RV that is included in the decoding soft-buffer is judged to be valid (step S111: YES), the data of the storage soft-buffer is replaced with the data of the decoding soft-buffer (step S112). That is, in step 112, the newest state of the decoding soft-buffer, which is not polluted, is stored in the storage soft-buffer.

When the RV that is included in the decoding soft-buffer is judged to be invalid (step S111: NO), the data of the decoding soft-buffer is replaced with the data of the storage soft-buffer (step S113).

After step S112 or S113, the received data and the data of the decoding soft-buffer are combined (step S114). Then, decoding of the combined data is tried (step S115).

After step S103 or the decoding process of S115, whether or not the decoding has succeeded is judged (step S121). When the decoding is judged to have succeeded (step S121: YES), an ACK is generated and transmitted to the radio base station (step S122).

On the other hand, if the decoding is judged to have failed (step S121: NO), the data of the decoding soft-buffer is replaced with the data that has been tried for decoding (step S131). Then, a NACK is generated and transmitted to the radio base station (step S132).

As has been described above, according to embodiment 4 of the present invention, a structure is provided in which, unlike embodiment 1.1 or 2.1, DL grants are transmitted in the (E)PDCCH regardless of the result of LBT, and, even when fake transmission occurs, it is still possible to perform the HARQ process by using soft-buffers as effectively as possible.

(Compatibility with Conventional Control Channels)

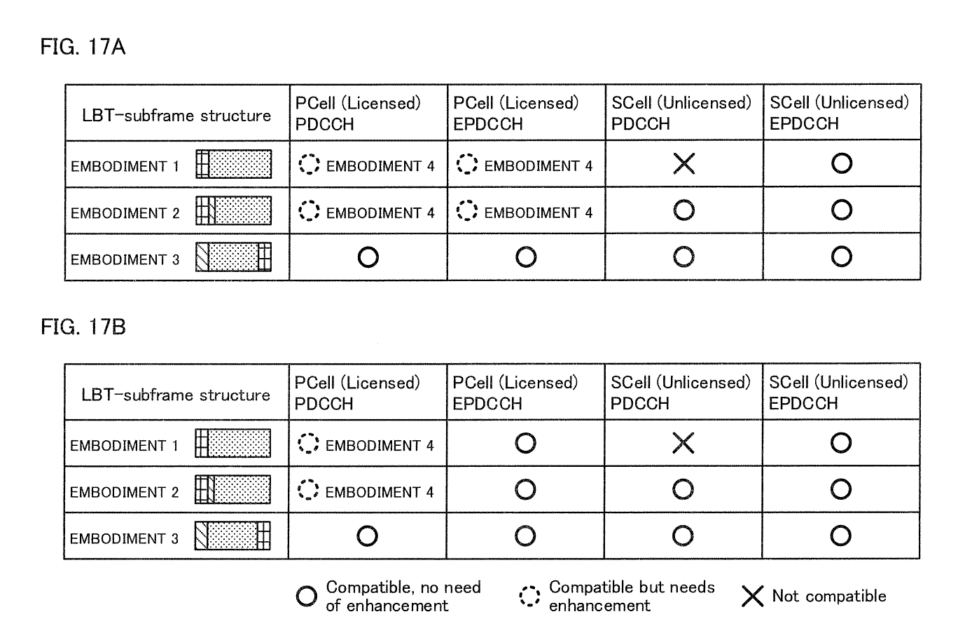

FIG. 17 provide diagrams to show the compatibility between control channels in licensed band/unlicensed band cells and conventional control channels, employing each embodiment of the present invention. FIG. 17A shows a case where eNB category 1 is used, and FIG. 17B shows a case where eNB category 2 is used.

The embodiment of the present invention are all designed to change an unlicensed band (SCell) subframe configuration for LBT use, and therefore compatibility with licensed bands (PCell) is secured. However, according to embodiments 1 and 2, the LBT symbols overlap the conventional PDCCH symbols, and, for the PDCCH of the PCell, it is preferable to solve the problem with HARQ regarding fake transmission by using embodiment 4.

When DCI is reported in the EPDCCH of the PCell, fake transmission is produced because of the premise that, in eNB category 1, the content of transmission cannot be changed in the middle of a subframe after LBT. On the other hand, the premise of eNB category 2 is that the content of transmission can be changed after LBT, so that it is possible to avoid fake transmission unless LBT [symbol] EPDCCH transmission are carried out at the same time. Therefore, for the EPDCCH of the PCell, it is preferable to employ embodiment 4 for eNB category 1.

As for the PDCCH of the SCell, embodiment 2 and 3 are structured to transmit the PDCCH in predetermined symbols at the top of a subframe, so that compatibility with the conventional PDCCH is secured. On the other hand, embodiment 1 is structured not to transmit the PDCCH in unlicensed bands, and therefore is not compatible with the conventional PDCCH.

As for the EPDCCH of the SCell, each embodiment is compatible with the conventional EPDCCH.

As has been described above, it is preferable to determine which embodiment is to be applied to the subframe configuration in unlicensed bands based on the eNB category used, the parameters that relate to the subframe configuration to which symbol-level LBT is applied (for example, the LBT cycle, the number of LBT symbols, etc.) and so on. Note that a structure to switch around each embodiment for use may be used. In this case, information about the subframe configuration to use in unlicensed bands may be reported to the user terminal in a control signal (DCI), or may be reported in higher layer signaling (for example, MAC signaling, RRC signaling, a broadcast signal). Also, this report may be sent from a licensed band (PCell) or may be sent from an unlicensed band (SCell).

Note that, although each embodiment that has been described above assumes that the carrier where listening (LBT) is configured is the unlicensed band and the carrier where listening (LBT) is not configured is the licensed band, the application of the present invention is by no means limited to this. For example, it is equally possible that the carrier where listening (LBT) is configured is the licensed band and the carrier where listening (LBT) is not configured is an unlicensed band. Also, as for the PCell and the SCell, the combination of the licensed band and the unlicensed band is by no means limited to the configuration described above.

(Structure of Radio Communication System)

Now, the structure of the radio communication system according to an embodiment of the present invention will be described below. In this radio communication system, the radio communication methods according to the embodiments of the present invention are employed. Note that the radio communication methods of the above-described embodiments may be applied individually or may be applied in combination.

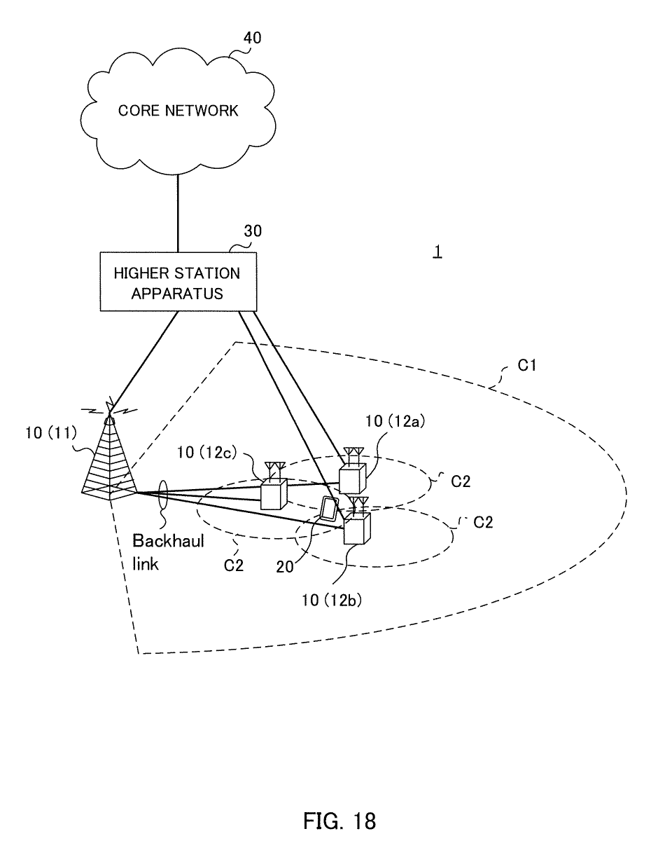

FIG. 18 is a diagram to show an example of a schematic structure of a radio communication system according to an embodiment of the present invention. Note that the radio communication system 1 shown in FIG. 18 is a system to incorporate, for example, an LTE system, super 3G, an LTE-A system and so on. The radio communication system 1 can adopt carrier aggregation (CA) to group a plurality of fundamental frequency blocks (component carriers) into one, where the LTE system bandwidth constitutes one unit, and/or adopt dual connectivity (DC). Also, the radio communication system 1 has a radio base station (for example, an LTE-U base station) that is capable of using unlicensed bands. Note that the radio communication system 1 may be referred to as “IMT-Advanced,” or may be referred to as “4G,” “5G,” “FRA” (Future Radio Access) and so on.

The radio communication system 1 shown in FIG. 18 includes a radio base station 11 that forms a macro cell C1, and radio base stations 12a to 12c that form small cells C2, which are placed within the macro cell C1 and which are narrower than the macro cell C1. Also, user terminals 20 are placed in the macro cell C1 and in each small cell C2. For example, a mode may be possible in which the macro cell C1 is used in a licensed band and the small cells C2 are used in unlicensed bands (LTE-U). Also, a mode may be also possible in which part of the small cells is used in a licensed band and the rest of the small cells are used in unlicensed bands.

The user terminals 20 can connect with both the radio base station 11 and the radio base stations 12. The user terminals 20 may use the macro cell C1 and the small cells C2, which use different frequencies, at the same time, by means of CA or DC. For example, it is possible to transmit assist information (for example, the DL signal configuration) related to a radio base station 12 (which is, for example, an LTE-U base station) that uses an unlicensed band, from the radio base station 11 to use a licensed band to the user terminals 20. Also, a structure may be employed here in which, when CA is used between a licensed band and an unlicensed band, one radio base station (for example, the radio base station 11) controls the scheduling of licensed band cells and unlicensed band cells.

Note that it is equally possible to use a structure in which a user terminal 20 connects with a radio base station 12, without connecting with the radio base station 11. For example, it is possible to use a structure in which a radio base station 12 to use an unlicensed band connects with the user terminals 20 in stand-alone. In this case, the radio base station 12 controls the scheduling of unlicensed band cells.

Between the user terminals 20 and the radio base station 11, communication is carried out using a carrier of a relatively low frequency band (for example, 2 GHz) and a narrow bandwidth (referred to as, for example, “existing carrier,” “legacy carrier” and so on). Meanwhile, between the user terminals 20 and the radio base stations 12, a carrier of a relatively high frequency band (for example, 3.5 GHz and so on) and a wide bandwidth may be used, or the same carrier as that used in the radio base station 11 may be used. Note that the configuration of the frequency band for use in each radio base station is by no means limited to these. Between the radio base station 11 and the radio base stations 12 (or between two radio base stations 12), wire connection (optical fiber, the X2 interface, etc.) or wireless connection may be established.

The radio base station 11 and the radio base stations 12 are each connected with a higher station apparatus 30, and connected with a core network 40 via the higher station apparatus 30. Note that the higher station apparatus 30 may be, for example, an access gateway apparatus, a radio network controller (RNC), a mobility management entity (MME) and so on, but is by no means limited to these. Also, each radio base station 12 may be connected with higher station apparatus 30 via the radio base station 11.

Note that the radio base station 11 is a radio base station having a relatively wide coverage, and may be referred to as a “macro base station,” a “central node,” an “eNB” (eNodeB), a “transmitting/receiving point” and so on. Also, the radio base stations 12 are radio base stations having local coverages, and may be referred to as “small base stations,” “micro base stations,” “pico base stations,” “femto base stations,” “HeNBs” (home eNodeBs), “RRHs” (Remote Radio Heads), “transmitting/receiving points” and so on. Hereinafter the radio base stations 11 and 12 will be collectively referred to as “radio base stations 10,” unless specified otherwise. The user terminals 20 are terminals to support various communication schemes such as LTE, LTE-A and so on, and may include both mobile communication terminals and fixed communication terminals.

In the radio communication system 1, as radio access schemes, OFDMA (Orthogonal Frequency Division Multiple Access) is applied to the downlink, and SC-FDMA (Single-Carrier Frequency Division Multiple Access) is applied to the uplink. OFDMA is a multi-carrier communication scheme to perform communication by dividing a frequency band into a plurality of narrow frequency bands (subcarriers) and mapping data to each subcarrier. SC-FDMA is a single-carrier communication scheme to mitigate interference between terminals by dividing the system band into bands formed with one or continuous resource blocks per terminal, and allowing a plurality of terminals to use mutually different bands. Note that the uplink and downlink radio access schemes are by no means limited to the combination of these.

In the radio communication system 1, a downlink shared channel (PDSCH: Physical Downlink Shared CHannel), which is used by each user terminal 20 on a shared basis, a broadcast channel (PBCH: Physical Broadcast CHannel), downlink L1/L2 control channels and so on are used as downlink channels. User data, higher layer control information and predetermined SIBs (System Information Blocks) are communicated in the PDSCH. Also, MIBs (Master Information Blocks) are communicated in the PBCH.

The downlink L1/L2 control channels include a PDCCH (Physical Downlink Control CHannel), an EPDCCH (Enhanced Physical Downlink Control CHannel), a PCFICH (Physical Control Format Indicator CHannel), a PHICH (Physical Hybrid-ARQ Indicator CHannel) and so on. Downlink control information (DCI) including PDSCH and PUSCH scheduling information is communicated by the PDCCH. The number of OFDM symbols to use for the PDCCH is communicated by the PCFICH. HARQ delivery acknowledgement signals (ACKs/NACKs) in response to the PUSCH are communicated by the PHICH. The EPDCCH may be frequency-division-multiplexed with the PDSCH (downlink shared data channel) and used to communicate DCI and so on, like the PDCCH.

In the radio communication system 1, an uplink shared channel (PUSCH: Physical Uplink Shared CHannel), which is used by each user terminal 20 on a shared basis, an uplink control channel (PUCCH: Physical Uplink Control CHannel), a random access channel (PRACH: Physical Random Access CHannel) and so on are used as uplink channels. User data and higher layer control information are communicated by the PUSCH. Also, downlink radio quality information (CQI: Channel Quality Indicator), delivery acknowledgement signals and so on are communicated by the PUCCH. By means of the PRACH, random access preambles for establishing connections with cells are communicated.

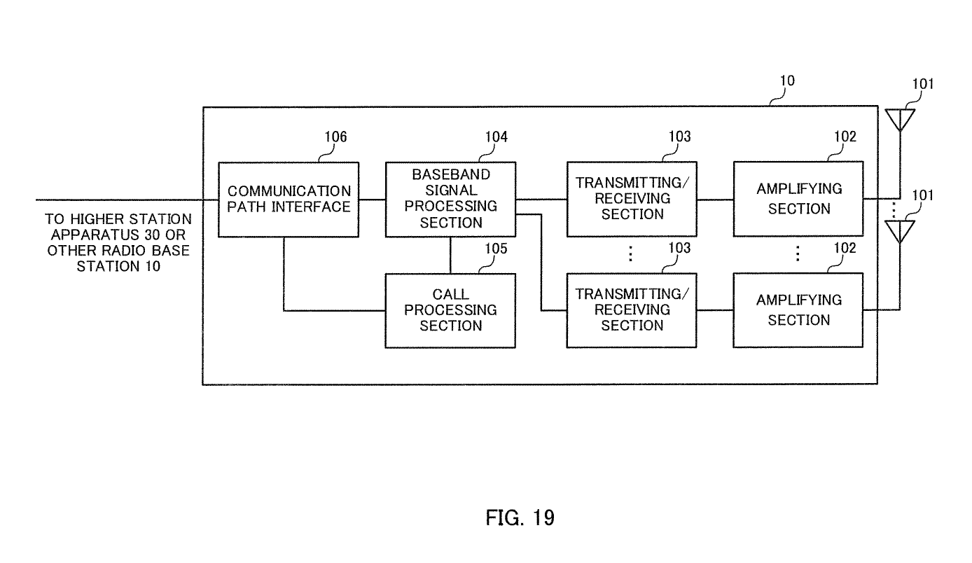

FIG. 19 is a diagram to show an example of overall structure of a radio base station according to one embodiment of the present invention. The radio base station 10 has a plurality of transmitting/receiving antennas 101 for MIMO transmission, amplifying sections 102, transmitting/receiving sections 103, a baseband signal processing section 104, a call processing 105 and a communication path interface 106. Note that the transmitting/receiving sections 103 may be comprised of transmitting sections and receiving sections.

User data to be transmitted from the radio base station 10 to a user terminal 20 on the downlink is input from the higher station apparatus 30, into the baseband signal processing section 104, via the transmission path interface 106.

In the baseband signal processing section 104, the user data is subjected to a PDCP (Packet Data Convergence Protocol) layer process, user data division and coupling, RLC (Radio Link Control) layer transmission processes such as RLC retransmission control, MAC (Medium Access Control) retransmission control (for example, an HARQ (Hybrid Automatic Repeat reQuest) transmission process), scheduling, transport format selection, channel coding, an inverse fast Fourier transform (IFFT) process and a precoding process, and the result is forwarded to each transmitting/receiving section 103. Furthermore, downlink control signals are also subjected to transmission processes such as channel coding and an inverse fast Fourier transform, and forwarded to each transmitting/receiving section 103.

Also, the baseband signal processing section 104 reports, to the user terminal 20, control information (system information) for allowing communication in the cell, through higher layer signaling (for example, RRC signaling, broadcast information and so on). The information for allowing communication in the cell includes, for example, the system bandwidth on the uplink, the system bandwidth on the downlink, and so on.

Also, assist information related to unlicensed band communication may be transmitted from the radio base station (for example, the radio base station 11) to the user terminal 20 by using a licensed band.

Each transmitting/receiving section 103 converts baseband signals that are pre-coded and output from the baseband signal processing section 104 on a per antenna basis, into a radio frequency band. The radio frequency signals having been subjected to frequency conversion in the transmitting/receiving sections 103 are amplified in the amplifying sections 102, and transmitted from the transmitting/receiving antennas 101. For the transmitting/receiving sections 103, transmitters/receivers, transmitting/receiving circuits or transmitting/receiving devices that can be described based on common understanding of the technical field to which the present invention pertains can be used.

Meanwhile, as for uplink signals, radio frequency signals that are received in the transmitting/receiving antennas 101 are each amplified in the amplifying sections 102. Each transmitting/receiving section 103 receives uplink signals amplified in the amplifying sections 102. The received signals are converted into the baseband signal through frequency conversion in the transmitting/receiving sections 103, and output to the baseband signal processing section 104. Also, the transmitting/receiving sections 103 receive a signal that includes predetermined information about the PUSCH transmission from the user terminal 20, and outputs this to the baseband signal processing section 104.

In the baseband signal processing section 104, user data that is included in the uplink signals that are input is subjected to a fast Fourier transform (FFT) process, an inverse discrete Fourier transform (IDFT) process, error correction decoding, a MAC retransmission control receiving process, and RLC layer and PDCP layer receiving processes, and forwarded to the higher station apparatus 30 via the communication path interface 106. The call processing section 105 performs call processing such as setting up and releasing communication channels, manages the state of the radio base station 10 and manages the radio resources.

The communication path interface section 106 transmits and receives signals to and from the higher station apparatus 30 via a predetermined interface. Also, the communication path interface 106 may transmit and receive signals (backhaul signaling) to and from other radio base stations 10 (for example, neighboring radio base stations) via an inter-base station interface (for example, optical fiber, the X2 interface, etc.). For example, the communication path interface 106 may transmit and receive information about the subframe configuration that relates to LBT, to and from other radio base station 10.

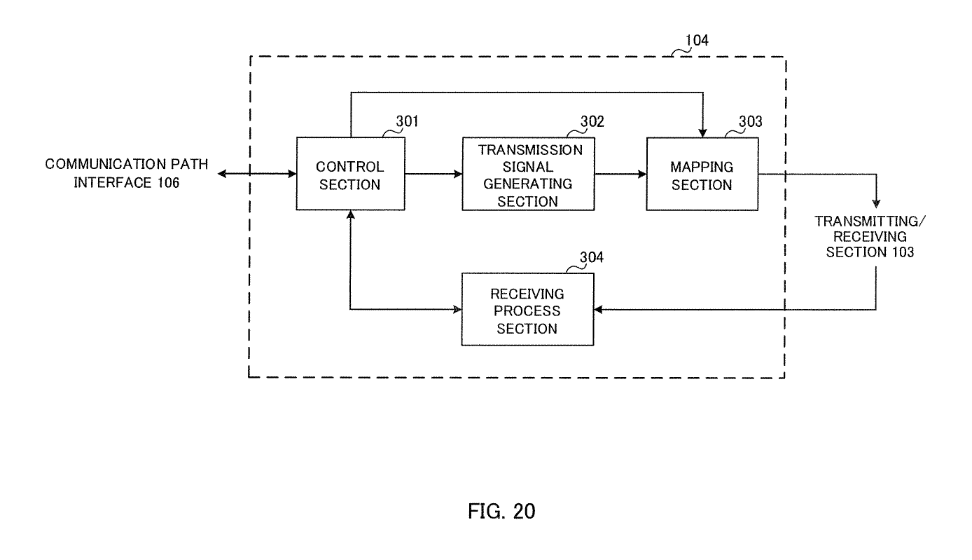

FIG. 20 is a diagram to show an example of a functional structure of a radio base station according to one embodiment of the present invention. Note that, although FIG. 20 primarily shows functional blocks that pertain to characteristic parts of the present embodiment, the radio base station 10 has other functional blocks that are necessary for radio communication as well.

As shown in FIG. 20, the baseband signal processing section 104 provided in the radio base station 10 has a control section (scheduler) 301, a transmission signal generating section 302, a mapping section 303 and a receiving process section 304.

The control section (scheduler) 301 controls the scheduling of (for example, allocates resources to) downlink data signals that are transmitted in the PDSCH and downlink control signals that are communicated in the PDCCH and/or the enhanced PDCCH (EPDCCH). Also, the control section 301 controls the scheduling of downlink reference signals such as system information, synchronization signals, the CRS (Cell-specific Reference Signal), the CSI-RS (Channel State Information Reference Signal) and so on.

Also, the control section 301 controls the scheduling of uplink reference signals, uplink data signals that are transmitted in the PUSCH, uplink control signals that are transmitted in the PUCCH and/or the PUSCH, RA preambles that are transmitted in the PRACH, and so on. Note that, when a licensed band and an unlicensed band are scheduled with one control section (scheduler) 301, the control section 301 might control communication in licensed band cells and unlicensed band cells. For the control section 301, a controller, a control circuit or a control device that can be described based on common understanding of the technical field to which the present invention pertains can be used.

The control section 301 has parameters that relate to the subframe configuration to which symbol-level LBT is applied (for example, the LBT cycle, the number of LBT symbols, the LBT subframe offset, the burst length, the number of PDCCH symbols that follow LBT symbols, etc.), and, based on these, controls the symbols and subframes of the carrier where LBT is configured (embodiments 1 to 3).

Also, the control section 301 may output the above subframe configuration-related parameters to the transmission signal generating section 302, and command the mapping section 303 to map signals that include information about these parameters.

Also, when cross-carrier scheduling is executed from a carrier where LBT is not configured (for example, a licensed band cell) to a carrier where LBT is configured (for example, an unlicensed band cell) via the (E)PDCCH, the control section 301 may acquire the LBT result in the previous LBT cycle from the receiving process section 304, and, based on this LBT result, control the information to include in the DCI to be transmitted in this (E)PDCCH (embodiment 4). For example, the control section 301 may apply control so that a bit (for example, one bit) to indicate whether or not an RV in a soft-buffer is valid is included in DCI as a fake RV indicator.

The transmission signal generating section 302 generates DL signals (downlink control signals, downlink data signals, downlink reference signals and so on) based on commands from the control section 301, and outputs these signals to the mapping section 303. For example, the transmission signal generating section 302 generates DL assignments, which report downlink signal allocation information, and UL grants, which report uplink signal allocation information, based on commands from the control section 301. Also, the downlink data signals are subjected to a coding process and a modulation process, based on coding rates and modulation schemes that are determined based on channel state information (CSI) from each user terminal 20 and so on. For the transmission signal generating section 302, a signal generator, a signal generating circuit or a signal generating device that can be described based on common understanding of the technical field to which the present invention pertains can be used.

The mapping section 303 maps the downlink signals generated in the transmission signal generating section 302 to radio resources based on commands from the control section 301, and outputs these to the transmitting/receiving sections 103. For the mapping section 303, mapper, a mapping circuit or a mapping device that can be described based on common understanding of the technical field to which the present invention pertains can be used.

The receiving process section 304 performs receiving processes (for example, demapping, demodulation, decoding and so on) of UL signals (for example, delivery acknowledgement signals (HARQ-ACK), data signals that are transmitted in the PUSCH, and so on) transmitted from the user terminals. The receiving process section 304 constitutes the measurement section according to the present invention. For the receiving process section 304, a signal processor/measurer, a signal processing/measurement circuit or a signal processing/measurement device that can be described based on common understanding of the technical field to which the present invention pertains can be used.

The receiving process section 304 executes LBT in a carrier where LBT is configured (for example, an unlicensed band), by using LBT symbols in a predetermined subframe, based on commands from the control section 301, and outputs the result of LBT (for example, judgment as to whether the channel state is clear or busy) to the control section 301. Also, the receiving process section 304 may measure the received power (RSRP), channel states and so on by using the received signals. Note that the processing results and the measurement results may be output to the control section 301.

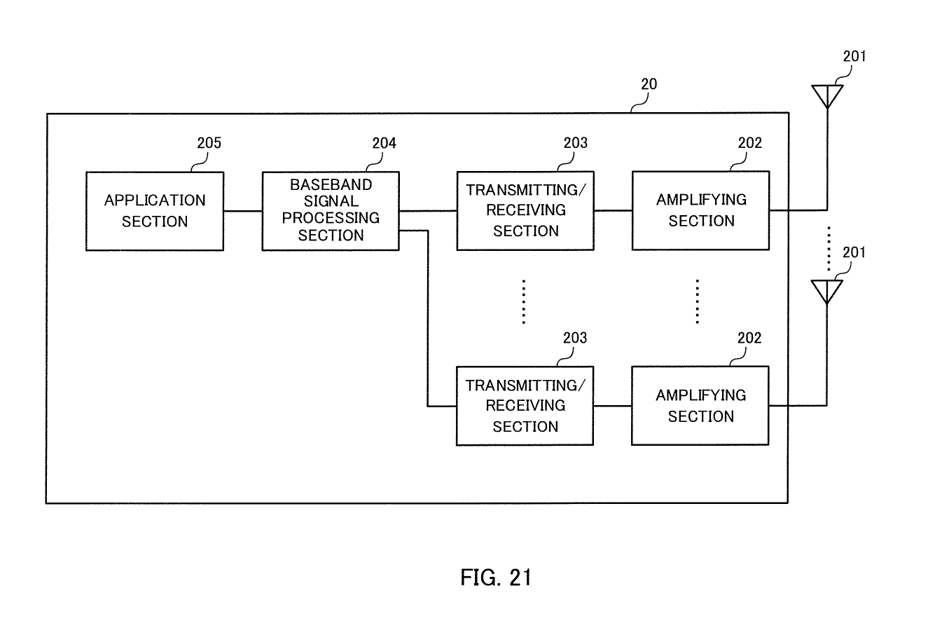

FIG. 21 is a diagram to show an example of an overall structure of a user terminal according to one embodiment of the present invention. A user terminal 20 has a plurality of transmitting/receiving antennas 201 for MIMO communication, amplifying sections 202, transmitting/receiving sections 203, a baseband signal processing section 204 and an application section 205. Note that the transmitting/receiving sections 203 may be comprised of transmitting sections and receiving sections.

Radio frequency signals that are received in a plurality of transmitting/receiving antennas 201 are each amplified in the amplifying sections 202. Each transmitting/receiving section 203 receives the downlink signals amplified in the amplifying sections 202. The received signals are subjected to frequency conversion and converted into the baseband signal in the transmitting/receiving sections 203, and output to the baseband signal processing section 204. For the transmitting/receiving sections 203, transmitters/receivers, transmitting/receiving circuits or transmitting/receiving devices that can be described based on common understanding of the technical field to which the present invention pertains can be used. The transmitting/receiving sections 203 are capable of transmitting/receiving UL/DL signals in unlicensed bands. Note that the transmitting/receiving sections 203 may be capable of transmitting/receiving UL/DL signals in licensed bands as well.

In the baseband signal processing section 204, the baseband signals that are input are subjected to an FFT process, error correction decoding, a retransmission control receiving process, and so on. Downlink user data is forwarded to the application section 205. The application section 205 performs processes related to higher layers above the physical layer and the MAC layer. Furthermore, in the downlink data, the broadcast information is also forwarded to the application section 205.

Meanwhile, uplink user data is input from the application section 205 into the baseband signal processing section 204. The baseband signal processing section 204 performs a retransmission control transmission process (for example, an HARQ transmission process), channel coding, pre-coding, a discrete Fourier transform (DFT) process, an IFFT process and so on, and the result is forwarded to each transmitting/receiving section 203. The baseband signal that is output from the baseband signal processing section 204 is converted into a radio frequency band in the transmitting/receiving sections 203. The radio frequency signals that are subjected to frequency conversion in the transmitting/receiving sections 203 are amplified in the amplifying sections 202, and transmitted from the transmitting/receiving antennas 201.

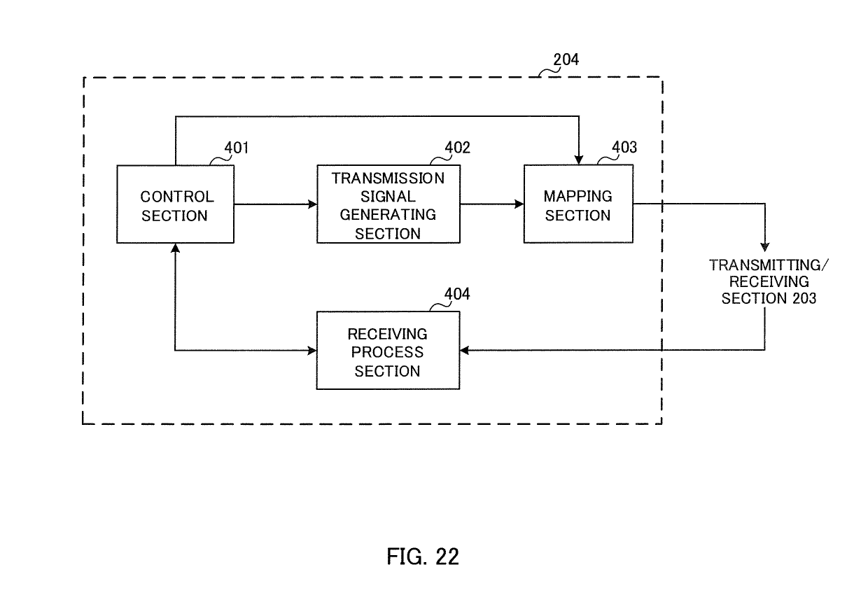

FIG. 22 is a diagram to show an example of a functional structure of a user terminal according to one embodiment of the present invention. Note that, although FIG. 22 primarily shows functional blocks that pertain to characteristic parts of the present embodiment, the user terminal 20 has other functional blocks that are necessary for radio communication as well.

As shown in FIG. 22, the baseband signal processing section 204 provided in the user terminal 20 has a control section 401, a transmission signal generating section 402, a mapping section 403 and a receiving process section 404.

The control section 401 acquires the downlink control signals (signals transmitted in the PDCCH/EPDCCH) and downlink data signals (signals transmitted in the PDSCH) transmitted from the radio base station 10, from the receiving process section 404. The control section 401 controls the generation of uplink control signals (for example, delivery acknowledgement signals (HARQ-ACK) and so on) and uplink data signals based on the downlink control signals, the results of deciding whether or not retransmission control is necessary for the downlink data signals, and so on. To be more specific, the control section 401 controls the transmission signal generating section 402 and the mapping section 403. For the control section 401, a controller, a control circuit or a control device that can be described based on common understanding of the technical field to which the present invention pertains can be used.

Based on parameters that relate to the subframe configuration and/or symbol configuration to execute LBT (for example, the LBT cycle, the number of LBT symbols, the LBT subframe offset, the burst length, the number of PDCCH symbols that follow LBT symbols, etc.), the control section 401 identifies the symbol configuration and subframe configuration used in the carrier where LBT is configured (embodiments 1 to 3). The above parameters may be acquired from information that is reported from the radio base station 10 and then input from the receiving process section 404, or may be configured in advance. Based on the identified configurations, the control section 401 controls the timing and period to execute LBT, for the receiving process section 404.

Also, the control section 401 the HARQ decoding results (for example, success, failure, etc.) of downlink data signals from the receiving process section 404, and controls the transmission signal generating section 402 and mapping section 403 to transmit ACKs/NACKs based on these results.

The transmission signal generating section 402 generates UL signals (uplink control signals, uplink data signals, uplink reference signals and so on) based on commands from the control section 401, and outputs these signals to the mapping section 403. For example, the transmission signal generating section 402 generates uplink control signals such as delivery acknowledgement signals (HARQ-ACKs), channel state information (CSI) and so on, based on commands from the control section 401. Also, the transmission signal generating section 402 generates uplink data signals based on commands from the control section 401. For example, when a UL grant is contained in a downlink control signal reported from the radio base station 10, the control section 401 commands the transmission signal generating section 402 to generate an uplink data signal. For the transmission signal generating section 402, a signal generator, a signal generating circuit or a signal generating device that can be described based on common understanding of the technical field to which the present invention pertains can be used.

The mapping section 403 maps the uplink signals generated in the transmission signal generating section 402 to radio resources based on commands from the control section 401, and output the result to the transmitting/receiving sections 203. For the mapping section 403, mapper, a mapping circuit or a mapping device that can be described based on common understanding of the technical field to which the present invention pertains can be used.

The receiving process section 404 performs receiving processes (for example, demapping, demodulation, decoding and so on) of the DL signals transmitted in licensed bands and unlicensed bands (for example, downlink control signals transmitted from the radio base station, downlink data signals transmitted in the PDSCH, and so on). The receiving process section 404 can constitute the receiving section according to the present invention. When the parameters that relate to the subframe configuration and/or symbol configuration to execute LBT are received from the radio base station 10, the receiving process section 404 outputs these to the control section 401.

Also, the receiving process section 404 may measure the received power (RSRP) and channel states by using the received signals. Note that the processing results and the measurement results may be output to the control section 401. For the receiving process section 404, a signal processor/measurer, a signal processing/measurement circuit or a signal processing/measurement device that can be described based on common understanding of the technical field to which the present invention pertains can be used.

The receiving process section 404 constitutes the HARQ process section according to the present invention, and applies HARQ processes to the data signals received. To be more specific, when a DL grant with a toggled NDI is received from a carrier where LBT is not configured, the receiving process section 404 may clear a soft buffer once, and store the data that corresponds to RV0 that is received in the PDSCH from the carrier where LBT is configured, in the soft-buffer (embodiment 4.1).

Also, the receiving process section 404 may have a decoding soft-buffer and a storage soft-buffer (embodiment 4.2). In this case, if the receiving process section 404 judges that the result of LBT at a DL grant transmission timing is LBT-busy, the receiving process section 404 replaces the content of the decoding soft-buffer with the content of the storage soft-buffer, and combines the downlink data and the content of the decoding soft-buffer. Also, when the receiving process section 404 judges that the result of LBT at a DL grant transmission timing is LBT-idle, the receiving process section 404 replaces the content of the storage soft-buffer with the content of the decoding soft-buffer, and combines the downlink data and the content of the decoding soft-buffer.

Note that the receiving process section 404 may be structured to start the (E)PDCCH/PDSCH receiving process upon detecting a predetermined signal (for example, the BRS (Beacon Reference Signal)) from the radio base station 10.

Note that the block diagrams that have been used to describe the above embodiments show blocks in functional units. These functional blocks (components) may be implemented in arbitrary combinations of hardware and software. Also, the means for implementing each functional block is not particularly limited. That is, each functional block may be implemented with one physically-integrated device, or may be implemented by connecting two physically-separate devices via radio or via wire and using these multiple devices.

For example, part or all of the functions of radio base stations 10 and user terminals 20 may be implemented using hardware such as ASICs (Application-Specific Integrated Circuits), PLDs (Programmable Logic Devices), FPGAs (Field Programmable Gate Arrays), and so on. Also, the radio base stations 10 and user terminals 20 may be implemented with a computer device that includes a processor (CPU), a communication interface for connecting with networks, a memory and a computer-readable storage medium that holds programs.

Here, the processor, the memory and/or others are connected with a bus for communicating information. Also, the computer-readable recording medium is a storage medium such as, for example, a flexible disk, an opto-magnetic disk, a ROM, an EPROM, a CD-ROM, a RAM, a hard disk and so on. Also, the programs may be transmitted from the network through, for example, electric communication channels. Also, the radio base stations 10 and user terminals 20 may include input devices such as input keys and output devices such as displays.

The functional structures of the radio base stations 10 and user terminals 20 may be implemented with the above-described hardware, may be implemented with software modules that are executed on the processor, or may be implemented with combinations of both. The processor controls the whole of the user terminals by running an operating system. Also, the processor reads programs, software modules and data from the storage medium into the memory, and executes various types of processes based on these. Here, the programs have only to be programs that make a computer execute each operation that has been described with the above embodiments. For example, the control section 401 of the user terminals 20 may be stored in the memory and implemented by a control program that operates on the processor, and other functional blocks may be implemented likewise.

Now, although the present invention has been described in detail above, it should be obvious to a person skilled in the art that the present invention is by no means limited to the embodiments described herein. For example, the above-described embodiments may be used individually or in combinations. The present invention can be implemented with various corrections and in various modifications, without departing from the spirit and scope of the present invention defined by the recitations of the claims. Consequently, the description herein is only provided for the purpose of illustrating examples, and should by no means be construed to limit the present invention in any way.

The disclosure of Japanese Patent Application No. 2014-226390, filed on Nov. 6, 2014, including the specification, drawings and abstract, is incorporated herein by reference in its entirety.

1. A user terminal that can communicate with a radio base station by using a carrier in which LBT (Listen Before Talk) is configured, the user terminal comprising:
a receiving section that receives downlink data that is transmitted based on an LBT result in a specific subframe that includes an LBT symbol; and
a control section that controls a receiving process of the downlink data, wherein:
the specific subframe is allocated periodically, and includes the LBT symbol in the last N symbols;
a subframe in a predetermined period following the specific subframe includes a PDCCH (Physical Downlink Control Channel) symbol in several symbols from the beginning; and
the control section controls the receiving process of the downlink data, taking into consideration the LBT symbol and the PDCCH symbol.

2. A user terminal that can communicate with a radio base station by using a carrier in which LBT (Listen Before Talk) is configured, the user terminal comprising:
a receiving section that receives downlink data that is transmitted based on an LBT result in a specific subframe that includes an LBT symbol; and
a control section that controls a receiving process of the downlink data, taking into consideration the LBT symbol,
wherein the specific subframe is allocated periodically, and, in N symbols from the beginning, does not include a PDCCH (Physical Downlink Control Channel) symbol, but includes the LBT symbol.

3. The user terminal according to claim 2, wherein the specific subframe and a subframe in a predetermined period following the specific subframe do not include the PDCCH symbol.

4. The user terminal according to claim 2, wherein:
the specific subframe includes the PDCCH symbol in M symbols following the LBT symbol;
the subframe in the predetermined period following the specific subframe includes the PDCCH symbol in several symbols from the beginning; and
the control section controls the receiving process of the downlink data, taking into consideration the LBT symbol and the PDCCH symbol.

5. The user terminal according to claim 1, wherein the control section controls the receiving process of the downlink data by identifying the LBT symbol based on information about configuration of the specific subframe and/or the LBT symbol.

6. The user terminal according to claim 1, wherein the receiving section receives control information (DL grant) pertaining to the downlink data in a carrier in which LBT is not configured, and receives the downlink data based on the DL grant.

7. The user terminal according to claim 6, further comprising an HARQ process section that applies an HARQ (Hybrid Automatic Repeat reQuest) process to the downlink data by using a decoding soft buffer and a storage soft buffer,
wherein the HARQ process section, when judging that an LBT result at a transmission timing of a given DL grant is LBT-busy, replaces content of the decoding soft buffer with content of the storage soft buffer, and combines the downlink data and the content of the decoding soft buffer.

8. The user terminal according to claim 7, wherein the HARQ process section judges whether the LBT result at the transmission timing of the given DL grant is LBT-busy or not based on information that is included in a DL grant that is different from the given DL grant.

9. A radio base station that communicates with a user terminal that can use a carrier in which LBT (Listen Before Talk) is configured, the radio base station comprising:
a measurement section that acquires an LBT result in a specific subframe that includes an LBT symbol; and
a transmission section that transmits downlink data based on the LBT result,
wherein the specific subframe is allocated periodically, and, in N symbols from the beginning, does not include a PDCCH (Physical Downlink Control Channel) symbol, but includes the LBT symbol.

10. A radio communication method for a user terminal that can communicate with a radio base station by using a carrier in which LBT (Listen Before Talk) is configured, the radio communication method comprising the steps of:
receiving downlink data that is transmitted based on an LBT result in a specific subframe that includes an LBT symbol; and
controlling a receiving process of the downlink data, taking into consideration the LBT symbol,
wherein the specific subframe is allocated periodically, and, in N symbols from the beginning, does not include a PDCCH (Physical Downlink Control Channel) symbol, but includes the LBT symbol.

11. The user terminal according to claim 2, wherein the control section controls the receiving process of the downlink data by identifying the LBT symbol based on information about configuration of the specific subframe and/or the LBT symbol.

12. The user terminal according to claim 3, wherein the control section controls the receiving process of the downlink data by identifying the LBT symbol based on information about configuration of the specific subframe and/or the LBT symbol.

13. The user terminal according to claim 4, wherein the control section controls the receiving process of the downlink data by identifying the LBT symbol based on information about configuration of the specific subframe and/or the LBT symbol.
